(19) United States
(12) Patent Application Publication
(10) Pub. No.: US 2023/0390751 A1
(43) Pub. Date: Dec. 7, 2023

(54) PHOTOCATALYTIC SYSTEM FOR ENANTIO-SELECTIVE ENRICHMENT

(71) Applicants: Yaron PAZ, Haifa (IL); Nitai ARBELL, Ramat Yishai (IL)

(72) Inventors: Yaron PAZ, Haifa (IL); Nitai ARBELL, Ramat Yishai (IL)

(21) Appl. No.: 18/250,246

(22) PCT Filed: Oct. 21, 2021
(86) PCT No.: PCT/IL2021/051248

§ 371 Date: Apr. 24, 2023

Related U.S. Application Data
(60) Provisional application No. 63/105,360, filed on Oct. 26, 2020.

(51) Int. Cl. B01J 35/00; B01J 21/06; B01J 21/04; B01J 21/08; B01J 27/10; B01J 37/02

(52) U.S. Cl. CPC B01J 35/004; B01J 21/063; B01J 21/04; B01J 21/08; B01J 27/10; B01J 37/0228; B01J 37/0244; B01J 37/0219; B01J 37/0221

(57) ABSTRACT

The present disclosure concerns catalytic systems for stereo-selective enrichment, more specifically enantio-selective templated catalytic units that are used for selective enrichment of stereoisomers, in particular enantiomers, in a mixture. The catalytic systems are based on forming chiral-specific active molecular cavities onto the surface of a photocatalytic substrate, such as titania, that are tailored to interact with a specific enantiomer, while a non-photocatalytic coating layer prevents interaction in other areas of the catalyst's surface.

### TECHNOLOGICAL FIELD

The present disclosure concerns catalytic systems for stereo-selective enrichment, more specifically enantio-selective templated catalytic units that are used for selective enrichment of stereoisomers, in particular enantiomers, in a mixture.

### BACKGROUND ART

References considered to be relevant as background to the presently disclosed subject matter are listed below:
[1] Lahav et al., Chem. Eur. J. 2001, 7, 3992-3997
[2] Goldsmith et al., Phys. Chem. Chem. Phys. 2006, 8, 63-67
[3] Brittain et al., Sci. Rep. 2019, 9, 15086-15094
[4] Pellissier, H., Tetrahedron 2011, 67, 3769-3802
[5] Sharabi et al., Appl. Catal. B 2010, 95, 169-178
[6] Fiorenza et al., J Photochem. Photobiol. A 2019, 380, 111872-111877
[7] Nussbaum et al., Phys. Chem. Chem. Phys. 2012, 14, 3392-3399
[8] Guo et al., Nanomaterials 2018, 8, 61-79
[9] Canlas et al., Nat. Chem. 2012, 4, 1030-1036
[10] U.S. Pat. No. 10,005,706
[11] U.S. Pat. No. 9,248,439
[12] Chinese patent application publication no. CN106009012
[13] Chinese patent application publication no. CN108299651
[14] Chinese patent application publication no. CN103940871
[15] Chinese patent application publication no. CN110596226

Acknowledgement of the above references herein is not to be inferred as meaning that these are in any way relevant to the patentability of the presently disclosed subject matter.

### BACKGROUND

Chirality is an unusual aspect of chemistry, a seemingly minor detail with surprisingly far-reaching consequences in physical, chemical, and biological systems. Despite their great similarity, oppositely handed enantiomers of pharmaceutical compounds are known to exhibit wildly different interactions with biological systems, which are themselves inherently chiral. Proteins and peptides are typically chiral structures, encoded in chiral DNA strands that are responsible for their biosynthesis. This gives rise to highly spatially selective interactions between these constructs and molecular substrates, as notoriously demonstrated by the thalidomide catastrophe. This drug, prescribed to pregnant women throughout the 1950s, exhibits strong antiemetic and sedative properties for its (+) enantiomer, while its (−) enantiomer has significant teratogenic effects, which culminated in tens of thousands of children being born with birth defects due to prenatal exposure.

Approximately 50% of drugs on the market today contain at least one chiral center. Many of these compounds exhibit pharmacological asymmetry, having one pharmaceutically useful enantiomer (known as a eutomer) and one or more enantiomers that are nonbeneficial or possibly harmful (distomers). Despite the documented pharmacological asymmetry, some of these compounds are still sold as racemates, even as research shows significant benefits of enantiopure formulations. Chiral compounds are also of importance in other fields, such as agriculture and optics.

To some extent, spontaneous racemization of the active compounds in drugs (i.e. spontaneous transformation of a relatively pure enantiomeric sample to a racemic mixture) is responsible for shortening their shelf-life. Most chemical processes produce both types of enantiomers (a racemic mixture). The various types of enantiomers have the same physical properties, making their separation very difficult and costly.

The challenge is, thus, obtaining chirally pure compounds, as both enantiomers respond to most chemical and physical separation processes identically. This is often obtained by either separation of racemic or scalemic mixtures of enantiomers, or, alternatively, by directly synthesizing the desired enantiomers using asymmetric synthesis methods.

Asymmetric synthesis (i.e. synthesis conditions that are tailored to predominantly produce a selected enantiomer), although highly efficient in terms of feedstock, requires the tailoring of complex, multistep, stereoselective reactions. These can be relatively expensive and may also require additional purification steps to reach sufficient optical purity.

Separation methods, based on the spatial differences between the enantiomers, successive recrystallization, and/or use of enantio-specific absorbing grafted polymers, require extensive development and optimization: namely, selecting an appropriate separation technique for a specific compound and optimizing its parameters, such as elution order and resolution or crystallization phase. As a general rule, the optimized parameters are hard to predict.

Another way to obtain enantiomeric separation is chiral molecular imprinting, i.e. the inclusion of an enantiomerically pure template into a separating matrix to achieve chiral recognition. Chiral imprinting in organic polymers was proposed as an alternative approach to the common chiral chromatography columns, as well as to retention-based separation techniques (e.g. membrane-based techniques). Nevertheless, imprinted polymers tend to lack structural stability, especially at elevated temperatures, significantly limiting their application in industry.

Imprinted oxides have been shown to induce spatial resolution for adsorptive, catalytic and electronic applications [1,2]. A third group of processes, which can be employed either pre- or post-synthesis, is called kinetic resolution. This group includes many different reactions which selectively favor one enantiomer over the other, for either the production of the target molecule or its further reaction into easily separable products [3,4].

The use of photocatalysts, especially anatase-phase titanium dioxide, for the degradation of organic compounds has been documented, particularly in environmental sciences and water treatment technologies. It relies on the light-dependent generation of electron-hole pairs that participate in complex redox reactions, usually mediated via radical species. Molecular imprinting in photocatalytic matrices has been shown to induce selectivity for the degradation of specific species over homologous alternatives, but alas, to date, no chiral-selectivity applications have been shown to be successful [5-6]. It has been shown that coating with ultrathin layers may have an effect on the properties of photocatalysts by altering the number of carriers arriving at the surface as well as by controlling the adsorption of reactants and the desorption of products [7-9].

Current solutions to obtain desired and specific types of enantiomers are expensive, time consuming, have poor throughput, and are not generic, hence require developing new methods and specific sets of conditions for each compound insentiently of similar methods developed for another compound. In many cases the market price of each separated enantiomer is more than 10-20 times higher than the price per mass of the racemic mixture. Therefore, there is a need for methods and catalytic systems that enable effective separation of a favorite enantiomer from a racemic mixture in a cost effective and simple manner.

### GENERAL DESCRIPTION

The present disclosure provides kinetic resolution methods and catalytic systems for obtaining enantiomeric enrichment in a mixture of stereoisomers, in particular mixtures of. The catalytic systems and kinetic resolution methods described herein are based on imprinting a surface of a photocatalyst to form chirally pure templates and minimizing or preventing adsorption of the enantiomers onto a non-templated surface of the photocatalyst. In other words, the catalytic system disclosed herein is based on forming chiral-specific active molecular sites onto the surface of the catalyst that are tailored to interact with a specific enantiomer, while preventing interaction in other areas of the catalyst's surface. While the templating (to be interchangeably also referred to herein as imprinting) is carried out by utilizing the specific enantiomer to be eliminated from the mixture, the catalytic systems and methods of this disclosure are generic in the sense that these are not limited by the specific compound or enantiomer as the templating molecule, and the systems and methods can be easily modified and implemented on any desired enantiomer.

Thus, by one of its aspects, the present disclosure provides a photocatalytic unit for increasing the relative amount of at least one first stereoisomer of a compound with respect to at least one second stereoisomer of the compound in a mixture comprising said first and second stereoisomers. The photocatalytic unit has a photocatalytic substrate comprising at least one photocatalyst, and at least one non-photocatalytic coating layer substantially coating said photocatalytic substrate, and a plurality of spaced-apart open molecular cavities defined at an external surface of the photocatalytic unit, the cavities being sized and shaped to correspond to a size and shape of said second stereoisomer, each of the cavities having at least a base portion thereof constituted by said photocatalytic substrate.

The term stereoisomer as used herein is meant to encompass an isomer that possess identical constitution as a corresponding stereoisomer, but which differs in the spatial arrangement of its atoms from the corresponding stereoisomer. In other words, two stereoisomers have the same molecular formula and sequence of bonded atoms, however differing one from the other in the spatial orientations of their atoms. Thus, while stereoisomers are identical to one another in their constitution, stereoisomers typically differ one from the other by their size and shape. By some embodiments, the stereoisomers may be enantiomers, diastereomers and/or cis-trans (E/Z) isomers.

According to some embodiments, the first and second stereoisomers are first and second enantiomers, respectively, of the compound.

Enantiomers are stereoisomers molecules having at least one chiral center, and which are non-superimposable mirror-images of one another.

The mixture of stereoisomers (e.g. a mixture of enantiomers) can, by some embodiments, comprise said at least one first stereoisomer and at least one second stereoisomer at any ratio, e.g. a racemic mixture, a non-racemic mixture, a mixture of more than two stereoisomers, etc.

In the photocatalytic unit of this disclosure, plurality of molecular cavities are defined at an external surface of the unit, and are sized and shaped to correspond to a size and shape of the second (undesired) stereoisomer. As stereoisomers (e.g. enantiomers) typically differ from each other in their size and shape, such that appropriately sized and shaped cavities permit for selective absorption of the second (undesired) stereoisomer into the cavity, while the first (desired) stereoisomer is prevented from such absorption and left in the mixture. Hence, the cavities permit both size and shape inclusion, resulting in effective separation between the first and second stereoisomers.

The cavities are voids formed at the external surface of the unit, and are open ended (i.e. open cavities), as to permit access of the second stereoisomer thereinto. Each cavity has a base, at least a portion thereof being constituted by the photocatalytic substrate. Thus, once a second stereoisomer (e.g. enantiomer) is adsorbed into the cavity, due to the matching of size and shape, it is forced to come into contact with the photocatalytic substrate to permit its decomposition, as will be described hereinbelow.

Each of the cavities has sidewalls that extend from the base portion of the cavity towards an opening of the cavity (i.e. towards the open end of the cavity), and together with the base, form a 3-dimensional void in the shape and size of the second stereoisomer. Thus, the cavities are typically in the shape and size of a single molecule of the second stereoisomer, the molecule being, by some embodiments, an enantiomer.

According to some embodiments, the sidewalls have a bottom portion formed in said photocatalytic substrate and a top portion formed in said non-photocatalytic coating layer. In such an arrangement, the base of the cavity and a bottom portion of its sidewalls are constituted by the photocatalytic substrate, effectively resulting in larger available surface for contacting the molecule of the second stereoisomer adsorbed into the cavity.

According to other embodiments, the sidewalls are substantially defined within said non-photocatalytic coating layer. In other words, in this embodiment, the base of the cavity is constituted by the photocatalytic substrate while the walls of the cavity are constituted by the non-photocatalytic coating.

By some embodiments, the photocatalytic unit comprises two or more types of cavities, each shaped and sized to adsorb and capture a different molecular entity.

In some embodiments, at least a portion of a surface of the cavity is associated with one or more binding increasing moieties. Such binding increasing moieties can, for example, be complexation moieties, and can function to increase or promote adsorption of the second stereoisomer, thereby capturing it within the cavity.

By some embodiments, the cavities are configured for adsorbing and degrading molecules containing one or more organometallic bonds, organic enantiomers, enantiomers of long polymeric chains, enantiomers of peptides or proteins (in a folded, misfolded or unfolded states), or of enantiomers of molecules based on an element other than carbon, such as phosphorus or silicon.

According to other embodiments, the cavities are configured for adsorbing and degrading of at least one alcohol, ether, ester, ketone, aldehyde, hydroxylic acid, aromatic rings, amine, amide, sulfide, disulfide, thiol, sulfenic acid, sulfinic acid, sulfonic acid, sulfonate ester, halide, siloxane, silanol, siloxide, silyl, silene, silole, phosphate, phosphonate, phosphinate, phosphine, phosphonium or mixtures thereof.

The photocatalytic substrate, as noted, comprises at least one photocatalyst. A photocatalyst is a material (compound or composition of matter) that is capable of initiating chemical reactions by absorbing electromagnetic waves, usually in the UV or visible part of the spectrum, thus forming charge carriers (electrons and holes) that arrive at the surface and participate in redox reactions that take place on the surface or in its vicinity. Hence, the photocatalytic units of this disclosure are used for photocatalysis of the second (undesired) stereoisomer (i.e. decomposition upon irradiation), hence reducing the concentration of the second stereoisomer in the mixture to effectively enrich the mixture with the first (desired) stereoisomer.

By some embodiments, the photocatalyst is in planar form, for example a plate, a film, a coating (continuous or non-continuous) layer over a non-reactive substrate, etc.

By some other embodiments, the photocatalyst substrate is in particulate form. When in particulate form, the photocatalyst substrate (and hence the photocatalytic unit) can be of a single type (with all of the particles substantially having the same geometrical form, size, and/or composition) or can be a mixture of two or more different types. The various populations of particles may differ in size, size distribution, shape, chemical composition, spectroscopic property, topology, and/or other physical or chemical characteristics. The particles can be selected amongst isotropic and anisotropic shaped particles. The particles may display any branched and net structures. Without being limited thereto, the particles may be symmetrical or unsymmetrical, may be elongated having a rod-like shape, round (spherical), elliptical, pyramidal, disk-like, branch, network or any irregular shape.

By some embodiments, the photocatalytic substrate particles (and hence also the units) are substantially spherical.

As used herein, the term spherical, or any lingual variation thereof, refers generally to a substantially (nearly) round-ball geometry. The term generally reflects on the spherical non-elongated shape of a particle, which need not be perfectly round in shape. The size of the spherical particle is typically the average diameter thereof.

According to some embodiments, the average particle size of the photocatalytic substrate particles is between about 4 nanometers (nm) and 20 micrometers (μm). By other embodiments, the average particle size of the photocatalytic substrate particles is between about 20 nm and 10 μm, between about 20 nm and 5 μm, or even between about 50 nm and 5 μm.

The term average particle size refers to the arithmetic mean of measured diameters of the particles. When the particle is non-spherical, the term means to denote the average particle size based on the equivalent diameter of the particle (based on its longest dimension).

According to some embodiments, the photocatalytic substrate is in the form of a porous or non-porous homogenous solid body, i.e. the entire solid body is made of one or more photocatalysts.

By a further embodiment, the photocatalytic substrate comprises a core coated by a layer of said at least one photocatalyst. The core is, by some embodiments, a non-photocatalytic core, a photocatalytic core (e.g. made of a different photocatalyst or comprising a different photocatalytic composition), or a co-catalyst.

The co-catalyst can, by way of example, be a noble metal (such as platinum, gold or palladium), an organic compound (e.g. activated carbon, fullerene, carbon nanotubes, graphene oxide and reduced graphene oxide), an oxide or a hydroxide such as silicon oxide, magnesium oxide, zirconium oxide, or another photocatalyst.

In embodiments where the photocatalyst is in the form of a layer coating a reactive or non-reactive carrier substrate (e.g. in a coated plate or core-shell configuration), the photocatalyst can be attached to the carrier substrate by a binder. The binder may be an inorganic binder, e.g. an oxide or a hydroxide, or an organic binder.

In some embodiments, the carrier substrate onto which the photocatalyst is attached is opaque to the wavelengths of radiation being used to activate the photocatalyst. In such embodiments, the irradiation of the photocatalytic unit can be carried out from the side of the photocatalyst (front illumination). Alternatively, the carrier substrate can be transparent or semi-transparent, and in such a case irradiation can be carried out from the carrier substrate side (back illumination), photocatalyst side, or both sides.

In order to increase quantum efficiency of the photocatalytic layer, the photocatalytic units of this disclosure can comprise, by some embodiments, an electrically conducting layer disposed between the photocatalyst layer and the carrier substrate, facilitating the application of voltage, thus increasing quantum efficiency by virtue of enhanced charge separation. Preferably, when the carrier substrate is transparent and illumination is from the back, this electrically conducting layer is made of a transparent material, for example of indium tin oxide.

By some embodiments, the photocatalytic unit can comprise one or more sensitizer compounds or compositions, different from said at least one photocatalyst or c-catalyst, functioning to increase the spectral range of photocatalysis operation of the unit.

According to some embodiments, the photocatalytic substrate comprises two or more photocatalysts.

By other embodiments, the at least one photocatalyst is doped by metals or non-metals to increase light absorption at specific wavelengths. The dopant can reside in the bulk of the photocatalyst or on the surface of the photocatalyst.

The photocatalyst, by some embodiments, absorbs light in the UV part of the spectrum, in the visible part of the spectrum, or both.

According to some embodiments, the photocatalyst is selected from oxides containing one element apart from oxygen (such as TiO₂, ZnO, Fe₂O₃, Bi₂O₃, WO₃, Ta₂O₅); oxides having corner-shared octahedral units (such as NbO₆, TaO₆, TiO₆); binary oxides (such as SrTiO₃, BaTa₂O₆, LaInO₃); oxides having a formula of A₂B₂O₇, where A is a trivalent metal (such as Bi) and B is a four valent metal (such as Y₂Ti₂O₇, Gd₂Ti₂O₇, La₂Ti₂O₇); oxides having the general formula of A₂, B*, B**O₇, where A is a trivalent metal, B* is a trivalent metal and B** is a pentavalent metal (such as La₃TaO₇, La₃NbO₇, Bi₂SbVO₇); oxides having the general formula of AB**O₄, where A is a trivalent metal, and B** is a pentavalent metal (such as InNbO₄, InTaO₄, BiNbO₄); oxyhalides (such as BiOCl, BiOI, BiOBr, BiOF) and mixtures of such oxyhalides (such as BiOClₓBr₁₋ₓ); nitrides (such as Ta₃Ns, graphitic carbon nitride); oxynitrides (such as TaON, LaTaO₂N); oxysulfates (such as Sm₂Ti₂O₅S₂); metal organic frameworks such as MIL177; polyoxometalites (POMs); and any mixture or combination thereof.

According to some embodiments, the photocatalyst comprises oxides, sulfates, sulfides, oxyhalides, nitrides, oxynitrides, selenides, carbides, phosphates, polyoxometalites, and/or metalorganic complexes, that comprise at least one of cadmium, cerium, gallium, iron, tungsten, thallium, lanthanum, yttrium, indium, vanadium, silver, molybdenum, tin, silicon, strontium, lead, astatine, chromium, antimony, selenium, or any mixture or alloy thereof, doped or undoped by at least one dopant.

According to some embodiments, the photocatalyst is selected from TiO₂, Bi₂O₃, WO₃, ZnO, NbO₆, TiO₆, TaO₆, InNbO₄, InTaO₄, BiNbO₄, BiTaO₄, Ga₂BiTaO₇, Bi₂FeNbO₇, Gd₃TaO₇, Bi₂AlNbO₇, Bi₂GaNbO₇, Bi₂InNbO₇, Y₃TaO₇, Yb₃NbO₇, La₃NbO₇, La₃TaO₇, CaTiO₃, SrTiO₃, Sr₃Ti₂O₇, Sr₄Ti₃O₁₀, K₂La₂Ti₃O₁₀, Rb₂La₂Ti₃O₁₀, Cs₂La₂Ti₃O₁₀, CsLa₂Ti₂NbO₁₀, La₂TiO₅, La₂Ti₃O₉, La₂Ti₂O₇, La₂Ti₂O₇:Ba, La₄CaTi₅O₁₇, KTiNbO₅, Na₂TiO₁₃, BaTi₄O₉, Gd₂Ti₂O₇, Y₂Ti₂O₇, α-Fe₂O₃, K₄Nb₆O₁₇, Rb₄Nb₆O₁₇, Ca₂Nb₂O₇, Sr₂Nb₂O₇, Ba₅Nb₄O₁₅, NaCa₂Nb₃O₁₀, ZnNb₂O₆, Cs₂Nb₄O₁₁, La₃NbO₇, Ta₂O₅, K₂PrTaO₁₅, K₃Ta₃Si₂O₁₃, K₃Ta₃B₂O₁₂, LiTaO₃, NaTaO₃, KTaO₃, AgTaO₃, KTaO₃:Zr, NaTaO₃:La, NaTaO₂:Sr, Na₂Ta₂O₆, K₂Ta₂O₆, CaTa₂O₆, SrTa₂O₆, BaTa₂O₆, NiTa₂O₆, Rb₄Ta₆O₁₇, Ca₂Ta₂O₇, Sr₂Ta₂O₇, K₂SrTa₂O₇, RbNdTa₂O₇, H₂La_{2/3}Ta₂O₇, K₂Sr_{1.5}Ta₃O₁₀, LiCa₂Ta₃O₁₀, KNa₂Ta₃O₁₀, Sr₅Ta₄O₁₅, Ba₅Ta₄O₁₅, H_{1.8}Sr_{0.81}Bi_{0.19}Ta₂O₇, Mg—Ta oxide, LaTaO₄, La₃TaO₇, PbWO₄, RbWNbO₆, RbWTaO₆, CeO₂:Sr, BaCeO₃, NaInO₂, CaIn₂O₄, SrIn₂O₄, LaInO₃, YₓIn₂₋ₓO₃ (0<x<2), NaSbO₃, CaSb₂O₆, Ca₂Sb₂O₇, Sr₂Sb₂O₇, Sr₂SnO₄, ZnGa₂O₄, Zn₂GeO₄, LiInGeO₄, Ga₂O₃, Ga₂O₃:Zn, LaTiO₂N, Ca_{0.25}La_{0.75}TiO_{2.25}N_{0.75}, TaON, Ta₃N₅, CaNbO₂N, CaTaO₂N, SrTaO₂N, BaTaO₂N, LaTaO₂N, Y₂Ta₂O₅N₂, Sm₂Ti₂O₅S₂, La—In oxysulfide, La₃NbO₇, Bi₂SbVO₇, BiOCl, BiOI, BiOBr, BiOF, BiOClₓBr₁₋ₓ (0<x<1), graphitic carbon nitride, and any mixture or combination thereof.

By some embodiments, the photocatalyst is an oxide. By such embodiments, the oxide is selected from titanium dioxide, zinc oxide, strontium titanate, bismuth oxide, bismuth oxihalide, tungsten oxide, and mixtures thereof.

By other embodiments, the photocatalyst is a metal salt. By such embodiments, the salt is selected from zinc sulfide, cadmium sulfide, molybdenum sulfide, antimony sulfide, indium sulfide, silver indium sulfide, gallium phosphate, and mixtures thereof.

By some other embodiments, the photocatalyst is a ceramic material. According to some embodiments, the photocatalyst is selected from carbon nitride, graphitic carbon nitride, boron carbon nitride, zinc selenide, cadmium selenide, and mixtures thereof.

By some other embodiments, the photocatalyst is selected from titanium dioxide, a binary or ternary oxide of bismuth, a binary or ternary oxide of zinc, and graphitic carbon nitride, and mixtures thereof.

As noted, the photocatalytic substrate is substantially coated by one or more non-photocatalytic coating layers.

By some embodiments, the layer of non-photocatalytic coating is an ultrathin layer, i.e. having a thickness of between about 1 and 70 atomic layers, e.g. between about 1 and 50 atomic layers, between about 1 and 30 atomic layers, between about 1 and 25 atomic layers, or even between about 1 and 20 atomic layers. According to some embodiments, the thickness of the non-photocatalytic coating layer is between about 1 and 12 atomic layers.

By some embodiments, the thickness of the non-photocatalytic coating layer is less than about 4 nanometers (nm). According to some embodiments, the thickness of the non-photocatalytic layer is less than about 3 nm, less than about 2 nm, less than about 1 nm, less than about 0.5 nm, or even less than about 0.2 nm.

The non-photocatalytic material (i.e. compound or composition of matter) from which the non-photocatalytic coating layer is made is typically selected to form chemical bonds (covalent, polar covalent, ionic, electrostatic or hydrogen bonds) with the photocatalyst. By some embodiments, the non-photocatalytic coating layer comprises at least one oxide or a hydroxide, for example aluminum oxide, silicon oxide, tin oxide, cerium oxide, zirconium oxide, hafnium oxide, lanthanum oxide and yttrium oxide, and mixtures thereof. By some other embodiments, the non-photocatalytic coating layer comprises at least one metal salt selected from halides, nitrates, nitrates, nitrides, sulfates, sulfides, phosphates, acetates, lactates, citrates, carbonates, and ascorbate salts, and any combination thereof.

By some embodiments, the non-photocatalytic layer comprises a salt selected from zinc sulfide, barium sulfide, strontium sulfide, silicon nitride, cerium carbonate, and mixtures thereof. By some further embodiments, the non-photocatalytic layer is a metal.

The layers of the non-photocatalytic coating may be made of the same or different non-photocatalytic material. In such embodiments, the non-photocatalytic coating layer can comprise two or more types of layers, differing in their composition, each of which has a thickness of at least one atomic layer. By way of example, the first layer is made of silicon dioxide of a O—Si—O—Si layer, on top of which a thicker layer of aluminum oxide is deposited.

According to other embodiments, the non-photocatalytic coating layer comprises one or more oligomers or polymers (e.g. linear, block, graft, random, alternating, branched polymers, or copolymers and polymeric blends).

According to some embodiments, the non-photocatalytic coating layer comprises at least one non-photocatalytic material selected from Al₂O₃, SiO₂, ZrO₂, HfO₂, La₂O₃, Y₂O₃, CeO₂, SnO₂, SnO, SrS, BaS, and Ce₂(CO₃)₃, and any mixture thereof.

By some embodiments, the photocatalyst is selected from titanium dioxide, a binary or ternary oxide of bismuth, a binary or ternary oxide of zinc, and graphitic carbon nitride, and mixtures thereof, and the non-photocatalytic coating layer comprises at least one non-photocatalytic material selected from Al₂O₃, SiO₂, ZrO₂, HfO₂, La₂O₃, Y₂O₃, CeO₂, SnO₂, SnO and mixtures thereof.

According to some embodiments, the photocatalytic units comprise an adsorption-suppression layer that is selectively deposited over the non-photocatalytic coating layer. The adsorption-suppression layer may be organic or inorganic, and functions to further reduce and at times substantially eliminate the adsorption of the second stereoisomer onto the surface of the non-photocatalytic coating layer.

By another aspect, the present disclosure provides a photocatalytic unit for increasing the relative amount of at least one first stereoisomer of a compound with respect to at least one second stereoisomer of the compound in a mixture comprising said first and second stereoisomers, the unit having a photocatalytic substrate comprising at least one photocatalyst, at least one non-photocatalytic coating layer substantially coating said photocatalytic substrate, and a plurality of spaced-apart open molecular cavities defined at an external surface of the unit, the cavities being sized and shaped to correspond to a size and shape of said second stereoisomer, each of the cavities having a base portion and sidewalls extending from the base portion towards an opening of the cavity, such that at least a base portion and a bottom portion of said side walls are constituted by said photocatalytic substrate and a top portion formed in said non-photocatalytic coating layer.

By a further aspect, the present disclosure provides a photocatalytic unit for increasing the relative amount of at least one first stereoisomer of a compound with respect to at least one second stereoisomer of the compound in a mixture comprising said first and second stereoisomers, the unit having a photocatalytic substrate comprising at least one photocatalyst, at least one non-photocatalytic coating layer substantially coating said photocatalytic substrate, and a plurality of spaced-apart open molecular cavities defined at an external surface of the unit, the cavities being sized and shaped to correspond to a size and shape of said second stereoisomer, each of the cavities having a base portion and sidewalls extending from the base portion towards an opening of the cavity, such that the base portion and the sidewalls are substantially defined within said non-photocatalytic coating layer.

By another aspect, the present disclosure provides a photocatalytic unit for increasing the relative amount of at least one first enantiomer of a compound with respect to at least one second enantiomer of the compound in a mixture comprising said first and second enantiomers, the unit having a photocatalytic substrate comprising at least one photocatalyst, at least one non-photocatalytic coating layer substantially coating said photocatalytic substrate, and a plurality of spaced-apart open molecular cavities defined at an external surface of the unit, the cavities being sized and shaped to correspond to a size and shape of said second enantiomer, each of the cavities having a base portion and sidewalls extending from the base portion towards an opening of the cavity, such that at least a base portion and a bottom portion of said side walls are constituted by said photocatalytic substrate and a top portion formed in said non-photocatalytic coating layer.

By a further aspect, the present disclosure provides a photocatalytic unit for increasing the relative amount of at least one first enantiomer of a compound with respect to at least one second enantiomer of the compound in a mixture comprising said first and second enantiomers, the unit having a photocatalytic substrate comprising at least one photocatalyst, at least one non-photocatalytic coating layer substantially coating said photocatalytic substrate, and a plurality of spaced-apart open molecular cavities defined at an external surface of the unit, the cavities being sized and shaped to correspond to a size and shape of said second enantiomer, each of the cavities having a base portion and sidewalls extending from the base portion towards an opening of the cavity, such that the base portion and the sidewalls are substantially defined within said non-photocatalytic coating layer.

By another one of its aspects, the disclosure provides a process of preparing a photocatalytic unit for increasing the relative amount of at least one first stereoisomer of a compound with respect to at least one second stereoisomer of the compound in a mixture comprising said first and second stereoisomers, the process comprises:
(a) associating molecules of said second stereoisomer onto a surface of a photocatalytic substrate that comprises at least one photocatalyst;
(b) selectively coating said surface by at least one non-photocatalytic material to obtain a non-photocatalytic coating layer on the photocatalytic substrate without substantially overcoating said second stereoisomer molecules; and
(c) applying conditions onto the coated photocatalytic substrate to degrade said molecules of second stereoisomer, thereby obtaining a photocatalytic unit comprising a photocatalytic substrate that comprises at least one photocatalyst, at least one non-photocatalytic coating layer substantially coating said photocatalytic substrate, with a plurality of spaced-apart open molecular cavities defined at an external surface of the photocatalytic unit, the cavities being sized and shaped to correspond to a size and shape of said second enantiomer, each of the cavities having at least a base portion thereof constituted by said photocatalytic substrate and sidewalls extending from the base portion towards an opening of the cavity, the sidewalls being substantially defined within said non-photocatalytic coating layer.

By another aspect, there is provided a process of preparing a photocatalytic unit for increasing the relative amount of at least one first stereoisomer of a compound with respect to at least one second stereoisomer of the compound in a mixture comprising said first and second stereoisomers, said process comprising:
(a′) preparing a photocatalytic substrate that comprises at least one photocatalyst having molecules of said second stereoisomer at least partially embedded into onto a surface of said substrate;
(b′) selectively coating said surface by at least one non-photocatalytic material to obtain a non-photocatalytic coating layer on the photocatalytic substrate without substantially overcoating said second stereoisomer molecules; and
(c′) applying conditions onto the coated photocatalytic substrate to degrade said molecules of second stereoisomer, thereby obtaining a photocatalytic unit comprising a photocatalytic substrate that comprises at least one photocatalyst, at least one non-photocatalytic coating layer substantially coating said photocatalytic substrate, with a plurality of spaced-apart open molecular cavities defined at an external surface of the unit, the cavities being sized and shaped to correspond to a size and shape of said second stereoisomer, each of the cavities having at least a base portion thereof constituted by said photocatalytic substrate and sidewalls extending from the base portion towards an opening of the cavity, the sidewalls having a bottom portion formed in said photocatalytic substrate and a top portion formed in said non-photocatalytic coating layer.

By some embodiments, the stereoisomers are enantiomers.

According to some embodiments, step (a′) comprises mixing said second stereoisomer (also interchangeably referred to herein as a template molecule) with a precursor of the photocatalyst.

By some embodiments, step (a′) is carried out in a solution, that comprises one or more solvents, said template molecules and said precursors. Possible solvents can be any liquid that dissolve both the precursor and the template molecule. By way of example, these solvents are often aqueous or organic solvents, in particular alcohols. In some embodiments, the solution further comprises chelating agents that form complexes with the precursor.

By some other embodiments, step (a′) is carried out in an emulsion, a micro-emulsion, mini-emulsion, nano-emulsion, a double emulsion, liposomal system, lyotropic liquid crystals, organogels or any combination thereof or any other type of micro- or nanostructured liquid. The emulsion may include, but not be limited to, the forms O/W, W/O, W/O/W, O/W/O, W/O₁/O₂, W/O₂/O₁, O₁/W/O₂, O₁/O₂/W, O₂/O₁/W, O₂/W/O₁ and combinations of these forms with bi-continuous phases.

In some embodiments, said precursor is an organometallic complex, which may, for example, comprise a metal ion having alkoxide ligands. In other embodiments, the precursor is a non-organic complex, for example a metal ion chemically associated to nitrate groups, halogen ligands, sulfate groups, and/or hydroxide ligands. In further embodiments, the precursor can comprise a metal ion chelated by a chelating agent, e.g. acetylacetone and carboxylic acids.

When preparing the units starting from step (a′), the ratio between the amount of second stereoisomer (i.e. template molecule) and precursor is calibrated to assure that the photocatalyst preserves its functional properties, and yet the surface concentration of the template molecule is sufficient to obtain a desired number of cavities on the surface of the unit. According to some embodiments, the ratio between the number of atoms in the photocatalyst to that of the second stereoisomer is 50-10,000,000. It should be understood that the optimal ratio can be changed and tailored according to the type of photocatalyst and the type of templating molecule.

When preparing units starting from step (a), by some embodiments, step (a) is preceded by a step (a0) of preparing said photocatalytic substrate. Step (a0) can, by some embodiments, be carried out by any one of sol-gel process, precipitation, electrospinning, atomic layer deposition (ALD), chemical vapor deposition (CVD), plasma-assisted deposition, solid-state reaction, deposition from gas phase or aerosol, or any other suitable method.

According to some embodiments of step (a), the second stereoisomer (i.e. the template molecules) is associated with the surface of the photocatalytic substrate by introducing the photocatalytic substrate into a solution that contains the template molecules. In some embodiments, step (a) is carried out at a temperature of below about 200° C. to promote adsorption of the template molecule onto the surface of the photocatalytic substrate. According to some embodiments, step (a) is carried out at a temperature of between about −50° C. and 200° C., between about −50° C. and 100° C., or even between −50° C. and 50° C. According to other embodiments, step (a) is carried out at a temperature of between about −20° C. and 150° C., between about −10° C. and 120° C., or even between about 0° C. and 100° C.

By some embodiments, step (a) is carried out in gas phase, or a precursor of the photocatalytic material is provided as an aerosol.

In some embodiments, the surface coverage by the template molecules is between about 0.05 and 50%, e.g. between about 0.1% and 30%, between about 1 and 20%, or even between about 3% and 10%.

According to some embodiments, small molecules or ions are added to the solution at steps (a) or (a′) to prevent coagulation of the template molecules at high concentrations. By way of example, charging the template molecules by altering the pH of the solution may prevent the formation of clusters.

In steps (b) and (b′) the surface of the photocatalytic substrate that comprises the template molecules is coated by a layer of non-photocatalytic coating. Typically, the coating is carried out in a selective manner, as to dispose ultrathin layers of the non-photocatalytic material onto the surface, without overcoating the template molecules residing at the surface of the photocatalyst (to enable their degradation or release from the surface at the next stages of preparation). According to some embodiments, selective coating is carried out by atomic layer deposition (ALD), molecular layer deposition (MLD), or by self-assembly of monolayers—techniques which allow for accurate selective coating with ultrathin layers, controlled at an atomic level thickness. By choosing the proper material to be used as non-photocatalytic coating layer by ALD or MLD it is possible to overcoat the photocatalyst in a coating that adheres strongly to the underlying photocatalyst without adhering to the template molecules residing on the surface of the photocatalyst. In self-assembly of monolayers, consecutive building and gradual stacking of monolayers is obtained. The control over the thickness of the non-photocatalytic layer is required for the efficient operation of the photocatalytic unit in its use in stereoisomeric enrichment processes, as the non-photocatalytic coating layer restrains the photocatalytic activity to areas that are not covered by the coating layer, i.e. to the cavities.

Selective coating is typically carried out at a temperature that does not harm or alter the shape of the second stereoisomer and does not cause desorption of these molecules from the photocatalyst's surface. In some embodiments, selective coating by said non-photocatalytic material is carried out at a temperature lower than about 400° C., e.g. lower than about 250° C., lower than about 100° C., lower than about 70° C., or even lower than about 35° C. According to some embodiments, selective coating is carried out at a temperature of between about 2° C. and 250° C. According to some embodiments, selective coating is carried out at a temperature of between about −10° C. and 100° C. According to some other embodiments, selective coating is carried out at a temperature range of between about 0° C. and 80° C. or even between about 20° C. and 60° C.

According to some embodiments, the selective coating is carried out by simultaneously introducing more than one ALD precursor, thus forming a layer that contains several types of non-photocatalytic molecules.

In steps (c) and (c′), following the growth of the coating layer, the template molecules are removed, thus leaving behind empty molecular cavities specifically shaped and sized to accommodate molecules identical to the template molecules. Such removal is carried out by applying conditions onto the coated photocatalytic substrate to degrade the molecules of second stereoisomer (i.e. the template molecules).

According to some embodiments, the removal conditions are exposing the photocatalyst to light, having a wavelength or wavelength band that induces its activation. By way of example, such light may be in the visible range of the spectrum, UV range of the spectrum or even in ranges of shorter wavelength, depending on the type of photocatalyst utilized.

According to other embodiments, the removal conditions are exposure to light at a wavelength or wavelength band that destroys/degrades/decomposes the template molecules. For example, such wavelength or wavelength band can be in spectral ranges of short UV (UV-C), deep UV, X-rays, gamma rays, or any combinations of photons belonging to different ranges.

According to some other embodiments, the removal conditions are obtained by chemical degradation of the template molecules. For example, oxidation by oxidative agents such as ozone, chlorine, fluorine, potassium permanganate, atomic oxygen and the like. Other examples include, but not limited to, reduction by reductive agents such as ammonium hydroxide, immersing in bases such as ammonia, and/or immersion in acids.

By some embodiments, the processes can comprise a step (d) or (d′), following steps (c) and (c′), accordingly, for processing the units into a free-standing film form or into a carrier-supported film. According to such embodiments, steps (d) or (d′) comprises preparing a film from said units. According to some embodiments, the film is porous to facilitate easy mass transport to the cavities.

According to some embodiments, binding of the units to form the film is carried out under elevated temperatures, e.g. between about 25° C. and 1400° C. By some embodiments, the temperature in which binding is carried out is between about 25° C. and 600° C., preferably between about 25° C. and 250° C.

By some other embodiments, binding of the units can be facilitated by utilizing one or more binding materials.

As noted, according to some embodiments, the photocatalytic units may comprise an adsorption-suppression layer is selectively deposited over the non-photocatalytic coating layer. The adsorption-suppression layer can be deposited onto the surface of the non-photocatalytic coating layer before or after steps (c) or (c′)—i.e. before removal of the template molecule or thereafter.

The preparation processes described herein can be applied to any desired templating molecule, and hence, are generic and can be adapted for enrichment of any desired stereoisomer is a mixture of stereoisomers. According to some embodiments, the template molecules (i.e. the second stereoisomer) comprise functional groups that form interactions with the photocatalyst or with its precursor, preferably functional groups capable of forming hydrogen bonds with the photocatalyst or with its precursors. Examples include, but are not limited to, alcohols, esters, ethers, carboxylic acids, amines and amides. In other embodiments, the template molecules are able to form π-π interactions with the photocatalyst or with its precursor, for example aromatic groups with graphitic carbon nitride, aromatic groups with graphene oxide or with carbon nanotubes. In some other embodiments, the interactions are between non-polar groups in the template molecules and non-polar moieties in the photocatalyst or its precursor. In some further embodiments, the interactions are between electrically charged functional groups in the template molecule and electrically charged sites in the photocatalyst or in its precursor.

According to some embodiments, the template molecules are at least partially associated with the non-photocatalytic coating layer. By some other embodiments, the template molecules are associated with both the photocatalyst and the non-photocatalytic coating layer.

In some embodiments, the template molecule is an organic molecule, containing one or more of the following functional groups: alcohol, ether, ester, ketone, aldehyde, hydroxylic acid, aromatic rings, amine, amide, sulfide, disulfide, thiol, sulfenic acid, sulfinic acid, sulfonic acid, sulfonate ester, halide, siloxane, silanol, siloxide, silyl, silene, silole, phosphate, phosphonate, phosphinate, phosphine, and phosphonium.

In other embodiments, the template molecule is a molecule containing one or more organometallic bonds, an organic molecule, a long polymeric chain, a peptide or a protein (in a folded, misfolded or unfolded state) and/or a molecule is based on an element other than carbon and exhibiting chiral chemistry, such as phosphorus or silicon.

According to some embodiments, the templating molecules have one or more chiral centers. Examples of suitable template molecules are leucyl-glycine, bupivacaine, ofloxacin, naproxen, ibuprofen, α-pinene, tramadol, oseltamivir, vancomycin and any other molecule having one or more chiral centers.

By another one of its aspects, the present disclosure provides a method for increasing the relative amount of at least one first stereoisomer of a compound with respect to at least one second stereoisomer of the compound in a first mixture comprising said first and second stereoisomers. The method comprises contacting at least one photocatalytic unit as described herein with said first mixture, under conditions permitting adsorption of molecules of said second stereoisomer into said cavities; and irradiating said first mixture in a wavelength or wavelength band to activate the photocatalyst to decompose said molecules of said second stereoisomer within the cavities, thereby obtaining a second mixture enriched by said first stereoisomer.

The first and second stereoisomers are, by some embodiments, first and second enantiomers, respectively, of said compound.

In some embodiments, the first mixture is in liquid form, for example a solution or a suspension in at least one of an aqueous medium, organic medium or a gas at supercritical conditions. By other embodiments, the first mixture is in gas form.

In some other embodiments, the first mixture is deposited on the photocatalyst surface and dried before irradiation.

According to some embodiments, introduction of the photocatalytic units into the first mixture can be carried out prior to removal of the template molecules from the cavities, such that irradiation causes removal of the template molecules from the cavities to free them for adsorption of said second stereoisomer from the first mixture.

By some embodiments, irradiation of the first mixture is at wavelengths (discrete wavelengths or wavelength band) in the ultraviolet range of the spectrum, visible part of the spectrum, deep UV part of the spectrum, X-ray part of the spectrum, infra-red part of the spectrum, or in a distinct pattern of alternating wavelengths.

The photon flux during irradiation can, by some embodiments, be between about 0.001 mW/cm² and 5 W/cm². By such embodiments, the photon flux can be between about 0.001 mW/cm² and 1 W/cm², between about 0.001 mW/cm² and 300 mW/cm², between about 0.1 mW/cm² and 0.5 W/cm², between about 0.01 mW/cm² and 20 mW/cm², preferably not lower than 0.1 mW/cm² and not higher than 20 mW/cm².

In some embodiments, irradiation is carried out concomitantly with cooling of the first mixture, e.g. in cases where relatively high flux of irradiation is utilized.

According to some embodiments, the amount of photocatalyst in the photocatalytic unit, when used as a powder in an aqueous medium, is between 0.001 grams per liter and 50 grams per liter, preferably up to 5 gram per liter, e.g. between 0.001 and 1 grams, between about 0.001 and 0.5 grams, or even between about 0.001 and 0.1 grams per liter.

In some embodiments, the units are used in conjunction with an external power source to supply positive or negative voltage bias to achieve favorable decomposition conditions within the cavities. Thus, by some embodiments, the process further comprises introducing a counter-electrode into the medium to facilitate introduction of energy into the system to assist in degradation of the target molecule. The counter-electrode is typically in contact with the non-photocatalytic coating layer. In some embodiments, the process further comprises application of an electric potential between the two electrodes. The potential can be between about −5V and 5V, e.g. between about −1V and 1V, between about −0.5 V and 0.5 V, between about −0.3 V and 0.3 V, or even between about −0.1 V and 0.1 V.

According to some embodiments, the process results in a second mixture that is substantially enantiomeric-pure.

By yet another aspect, there is provided a photocatalytic unit described herein, for use in a method of increasing the relative amount of at least one first stereoisomer of a compound with respect to at least one second stereoisomer of the compound in a first mixture comprising said first and second stereoisomers, said method comprising: contacting said photocatalytic unit with said first mixture, under conditions permitting absorption of molecules of said second stereoisomer into said cavities; and irradiating said first mixture in a wavelength or wavelength band to activate the photocatalyst to decompose said molecules of said second stereoisomer within the cavities, thereby obtaining a second mixture enriched by said first stereoisomer.

As used herein, the singular form a, an and the include plural references unless the context clearly dictates otherwise. For example, the term “a photocatalyst” or “at least one photocatalyst” may independently include a plurality of photocatalysts, including mixtures thereof.

As used herein, the term about is meant to encompass deviation of 20% from the specifically mentioned value of a parameter, such as temperature, pressure, concentration, etc.

Whenever a numerical range is indicated herein, it is meant to include any cited numeral (fractional or integral) within the indicated range. The phrases ranging ranges between a first indicate number and a second indicate number and “ranging/ranges from” a first indicate number “to” a second indicate number are used herein interchangeably and are meant to include the first and second indicated numbers and all the fractional and integral numerals therebetween. It should be noted that where various embodiments are described by using a given range, the range is given as such merely for convenience and brevity and should not be construed as an inflexible limitation on the scope of the invention. Accordingly, the description of a range should be considered to have specifically disclosed all the possible sub-ranges as well as individual numerical values within that range.

Throughout this specification and the claims which follow, unless the context requires otherwise, the word comprise, and variations such as comprises and comprising, will be understood to imply the inclusion of a stated integer or step or group of integers or steps but not the exclusion of any integer or step or group of integers and steps.

It is appreciated that certain features of this disclosure, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Processes of the present disclosure involve numerous process steps which may or may not be associated with other common physical-chemical processes so as to achieve the desired form and/or purity of each of the synthesized components. Unless otherwise indicated, such process steps, if present, may be set in different sequences without affecting the workability of the process and its efficacy in achieving the desired end result.

As used herein, substantially pure means sufficiently homogeneous to appear free of readily detectable impurities as determined by standard methods of analysis, such as thin layer chromatography (TLC), gel electrophoresis, high performance liquid chromatography (HPLC) and mass spectrometry (MS), used by those of skill in the art to assess such purity, or sufficiently pure such that further purification would not detectably alter the physical and chemical properties, such as enzymatic and biological activities, of the substance.

As used herein, the terms association and surface-association or any lingual variation thereof, refers to the chemical or physical force which holds the two entities together. Such force may be any type of chemical or physical bonding interaction known to a person skilled in the art. Non-limiting examples of such association interactions are ionic bonding, covalent bonding, coordination bonding, complexation, hydrogen bonding, van der Waals bonding, hydrophobicity-hydrophilicity interactions, etc.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-ID presents a schematic illustration of four types of photocatalytic units according to this disclosure: a unit consisted of a photocatalyst having molecular cavities formed by template molecules, with the surface of the photocatalyst being coated by a non-photocatalytic layer (FIG. 1A); a unit in which the cavities are formed within the non-photocatalytic layer (FIG. 1B); a unit in which the photocatalytic substrate is made of a photocatalytic core and shell structure (FIG. 1C); and a unit using two conjugated photocatalysts (FIG. 1D).

FIG. 2 is a schematic illustration of a photocatalytic unit of FIG. 1A, including preparation steps of the unit and use thereof in enantio-selective enrichment. For exemplification purposes, the template enantiomer is D-leucyl-glycine (D-LG) whereas the desired product is L-leucyl-glycine (L-LG).

FIG. 3 is a schematic illustration of a photocatalytic unit of FIG. 1B, including manufacturing steps of the enantiomeric enrichment entity and use thereof in enantio-selective enrichment. For exemplification purposes, the template enantiomer is L-L α-pinene (LLP) whereas the desired product is D-D α-pinene (DDP).

FIG. 4 shows the normalized amount of stearic acid deposited on titanium dioxide that had been coated with ultrathin layers of aluminum oxide, as a function of exposure time to UV light. Data is given for films without coating (circles), with 4 atomic layers, prepared at 50° C. (triangles), with 6 atomic layers, prepared at 50° C. (diamonds), with 8 atomic layers, prepared at 50° C. (squares), with 8 atomic layers, prepared at 60° C. (Xs) and with 12 atomic layers, prepared at 50° C. (crosses).

FIGS. 5A-5D are SEM-EDS images of exemplary photocatalytic units (also referred to as PEDs): TiO₂ film on glass without any coating (FIG. 5A); coated, imprinted plates with 6 ALD cycles (FIG. 5B); coated, imprinted plates with 10 ALD cycles (FIG. 5C); coated, imprinted plates with 14 ALD cycles (FIG. 5D).

FIG. 6 shows height distribution functions of the surface of the PEDs as obtained from AFM imaging measured over 50 nm×50 nm areas; z represents the height relative to the minimal height within the frame, while ρ is the prevalence. The solid line denotes the coated, nonimprinted sample (+,−), the dashed line denotes the coated, L-imprinted sample (+,L) templated with an 0.25 mg/mL solution of L-LeuGly, and the dot-dashed line denotes the L-imprinted sample templated with an 0.5 mg/mL solution of L-LeuGly.

FIGS. 7A-7C are normalized concentration curves of each single enantiomer test for: noncoated, nonimprinted photocatalytic film (−,−) (FIG. 7A); coated, L-imprinted PEDs (+,L) (FIG. 7B); and coated, D-imprinted PEDs (+,D) (FIG. 7C). Triangles represent the normalized concentration of the L-enantiomer, while circles represent the normalized concentration of the D-enantiomer.

FIG. 8 shows selectivity factors toward the L-enantiomer (k_{L}/k_{D}) for the single-enantiomer degradation tests for the noncoated, nonimprinted PED (−,−), the coated, L-imprinted PED (+,L) and the coated, D-imprinted PED (+,D).

FIGS. 9A-9D are chromatograms showing the separation of the L-enantiomer and the D-enantiomer of LeuGly, the degradation products, and the changing ratio between enantiomers upon degradation on the imprinted PEDs: the initial racemic solution (FIG. 9A); coated, nonimprinted (+,−) PED after 120 h of illumination (FIG. 9B); coated, L-imprinted (+,L) PED after 95.5 h of illumination (FIG. 9C); and coated, nonimprinted (+,D) PED after 115.5 h of illumination (FIG. 9D).

FIGS. 10A-10C are normalized enantiomeric concentrations during three types of racemate-enrichment tests: coated, nonimprinted PED (+,−) (FIG. 10A); coated, L-imprinted PED (+,L) (FIG. 10B); coated, D-imprinted PED (+,D) (FIG. 10C). Triangles represent the normalized concentration of the L-enantiomer, while circles represent the normalized concentration of the D-enantiomer. In all traces, negative times represent the “dark” adsorption stage.

FIG. 11 shows enrichment curves showing the relative amount of the L-enantiomer in each solution during the three types of racemate-enrichment tests: Xs represent coated, L-imprinted PEDs; squares represent coated, D-imprinted PEDs; triangles represent coated, nonimprinted devices.

FIG. 12 shows average values of the L-enantiomer selectivity factors (k_{L}/k_{D}) for various types of samples, during the racemate-enrichment experiments: (−,−) noncoated, nonimprinted plates; (+,−): coated, nonimprinted plates; (+,L) coated, L-imprinted plates; (+,D) coated, D-imprinted plates.

FIG. 13 shows the enantiomeric ratio of D-LG (i.e. D-LG/(D-LG+L-LG)) as a function of exposure time of particles comprising of imprinted titanium dioxide made by the titanyl-sulfate procedure of Example 2 and overcoated with 16 atomic layers of alumina.

FIG. 14 shows the measured enantiomeric ratio of the L-LG enantiomer (100×L/(D+L)) in the solution throughout the reaction, using L-imprinted photocatalyst, prepared by the procedure described in Example 3.

FIG. 15 shows the measured enantiomeric ratio of the L-LG enantiomer (100×L/(D+L)) in the solution throughout the reaction, using D-LG-imprinted photocatalyst, prepared by the procedure described in Example 3.

FIG. 16 shows the existence of a thin alumina layer on top of the native silicone oxide present on a silicon wafer surface, measuring 1.8 nm in thickness, corresponding to 10 ALD cycles of alumina growth.

FIG. 17 shows the L-enantiomer selectivity factors (k_{L}/k_{D}) for films BiOCl in an SiO₂ binder with no overcoating and no imprinting (−,−), 10 cycle overcoating and no imprinting (+,−), no overcoating and L-imprinting (−,L), 10 cycle overcoating and L-imprinting (+,L), no overcoating and D-imprinting (−,D), 10 cycle overcoating and D-imprinting (+,D).

FIG. 18 shows exemplary normalized enantiomeric concentrations (concentration after 125 hours of reaction time divided by the concentration at reaction start) for a coated BiOCl plate without imprinting (+,−) and a for coated BiOCl plate with L-LeuGly imprinting (+,L).

### DETAILED DESCRIPTION OF EMBODIMENTS

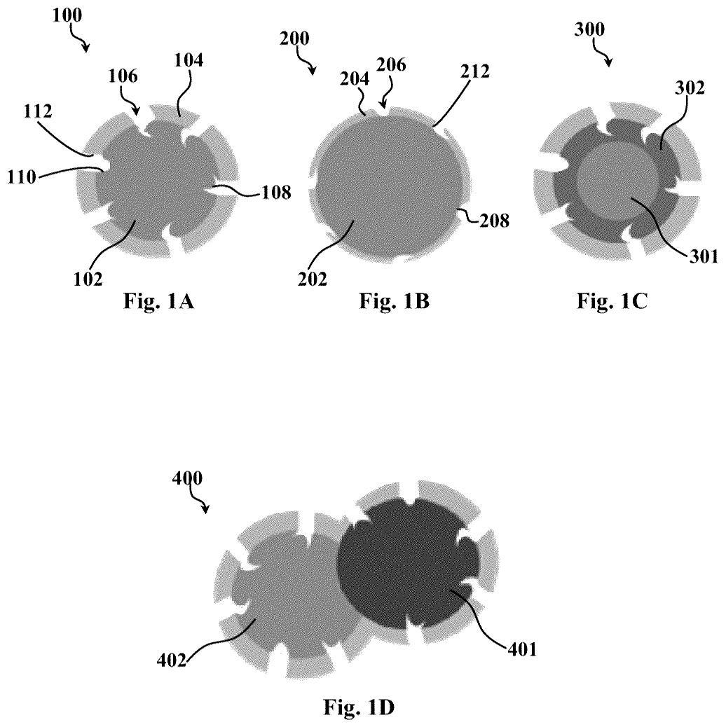

Turning first to FIGS. 1A-1D, shown are schematic representations of possible configurations of the photocatalytic units according to some embodiments of this disclosure.

In FIG. 1A, photocatalytic unit 100 includes a photocatalytic substrate 102 made of or comprising at least one photocatalyst, and a non-photocatalytic coating layer 104 substantially coating the photocatalytic substrate. Defined at the external surface of unit 100 are open, molecular cavities 106, which are spaced-apart on the surface of the unit and are sized and shaped to correspond to a size and shape of a molecule, typically a stereoisomer, that is desired to be removed from a stereoisomers' mixture. Each cavity 106 of this example has a base portion 108 that is constituted by the photocatalytic substrate. Each cavity also has sidewalls that extend from the base portion 108 towards the opening of the cavity—in this example the sidewalls have a bottom portion 110 formed in the photocatalytic substrate 102 and a top portion 112 formed in the non-photocatalytic coating layer 104. Hence, the shape of the cavity is formed partly within the photocatalytic substrate and partly within the non-photocatalytic coating layer.

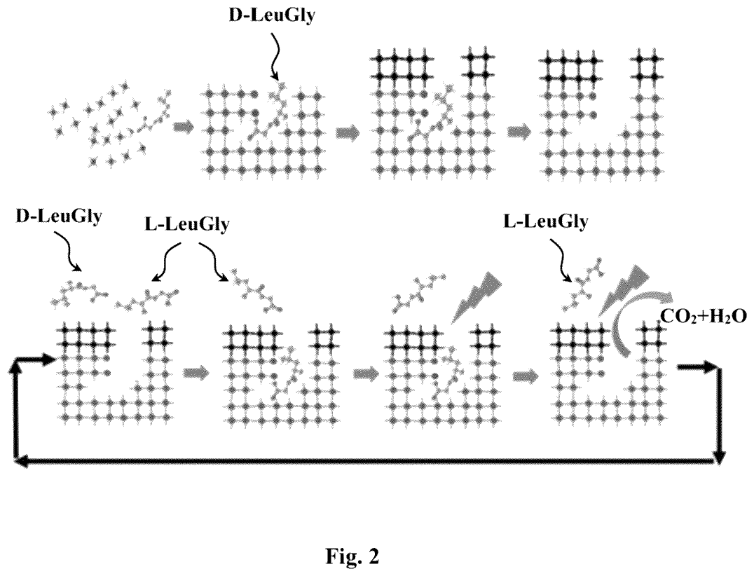

FIG. 2 schematically shows the production process of the photocatalytic unit of FIG. 1A. In this preparation process, a mixture of the template molecule (i.e. a second stereoisomer) is mixed with a precursor of the photocatalytic material, typically in a solution. Suitable conditions are applied to obtain a solid substrate made of the photocatalytic material, with the template molecules distributed over the surface of the photocatalyst and partially embedded therein. A thin non-photocatalytic coating layer is then selectively applied, e.g. by ALD or MLD technique, which permit coating of the surface of the photocatalytic substrate, however without overcoating the template molecules associated with onto the surface of the catalytic substrate. Once a desired thickness of the non-photocatalytic coating layer, e.g. between 1 and 20 atomic layers, conditions are applied to disassociate the template molecule, for example by irradiation, heating, desorption, chemical reaction, etc., leaving behind a molecular cavity having part of its volume defined in the photocatalytic substrate and another part of its volume defined in the non-photocatalytic coating layer, the cavity corresponding in shape and size to the template molecule. In this specific example, the templating molecule is D-LeuGly, and the cavities formed thereby are used to enrich a mixture of D-LeuGly and L-LeuGly enantiomers with the L-LeuGly enantiomer by capturing and degrading the D-LeuGly enantiomer within the cavities.

In FIG. 1B, a photocatalytic unit 200 has, similarly, the photocatalytic substrate 202 is substantially coated by a non-photocatalytic coating layer 204. In this example, each of the molecular cavities 206 has a base portion 208 that is constituted by the photocatalytic substrate, however with the sidewalls of the cavity 212 being substantially defined within the non-photocatalytic coating layer 204. The preparation process of the unit of FIG. 1B is shown in FIG. 3, and is similar to the process of FIG. 2, however with the difference being that the template molecule is adsorbed onto an already-prepared catalytic substrate. In such a preparation process, the cavities are predominantly formed within the non-photocatalytic coating layer, with only a base portion of the cavity being constituted by the catalytic substrate. In this specific example, the templating molecule is L,L α-pinene and the cavities formed thereby are used to enrich a mixture of L,L α-pinene and D,D α-pinene enantiomers with the D,D α-pinene enantiomer by capturing and degrading the L,L c-pinene enantiomer within the cavities.

Another configuration of the photocatalytic units of this disclosure is shown in FIG. 1C. The unit 300 is similar to that of unit 100 in FIG. 1A, however, in this example the photocatalytic substrate is in the form of a core-shell structure, having a core 301 coated by a photocatalytic layer 302. The core 301 can be non-reactive (e.g. non-photocatalytic), photocatalytic or be made of a co-catalyst.

Shown in FIG. 1D is another configuration of the photocatalytic units. The unit 400 is similar to that of unit 100 in FIG. 1A, however, in this example the photocatalytic substrate is in the form of conjugated parts 401 and 402, being both made of photocatalytic materials, or alternatively one being made of a photocatalytic material and the other being a co-catalyst.

It is of note that although in these schematic representations the photocatalytic units are shown to have a particulate, spherical shape, a person of skill would appreciate that the particles can assume any other suitable shape and size or that the photocatalytic unit can be of a planar configuration. Further, it is noted that the photocatalytic units in particulate form may be processed, by applying suitable means, into free-standing or carrier-supported photocatalytic films.

### Example 1

Glass slides, onto which films of TiO₂ were deposited, served as the starting catalytic substrates. LeuGly, a small dipeptide, was chosen as the model molecule due to its single chiral center, the variety of functional groups it has, allowing for several possible interactions with the matrix, and its commercial availability as an enantiopure compound. Al₂O₃ was chosen as the non-photocatalytic (i.e. activity-dampening) coating layer due to its significantly larger band gap relative to that of TiO₂, its favorable band locations, the relatively small lattice mismatch with that of anatase-phase titania, and its suitability for low-temperature, thermal Atomic Layer Deposition (ALD) growth with mild oxidizing reagents such as water.

### A. Activity Suppression

Testing the passivation capabilities of ALD-grown Al₂O₃ thin films on TiO₂ was performed by forming thin layers (˜60 nm) of anatase-phase titania on silica plates using spin-coating sol-gel method. Part of the plates were overcoated with Al₂O₃ by thermal ALD, using a MVD100E apparatus (SPTS Ltd.).

The ALD procedure comprised of the following stages: introducing the slides into the reaction chamber, pumping down to less than 1 mTorr, introducing nitrogen to obtain a working pressure of 20 mTorr, introducing 1 Torr of trimethylaluminum (TMA) for 1 sec, purging 5 times with nitrogen, pumping down to the working pressure, introducing 1 Torr of H₂O for 1 sec, purging 10 times with nitrogen, and pumping down to the working pressure, thus ending the deposition of a one-cycle overcoating layer. This process was repeated according to the predesigned number of layers.

The default temperature during the process was 50° C. Various thicknesses were tested, controlled by altering the number of overcoating cycles (0, 4, 6, 8, 12). In addition, an eight-layer sample was grown at 60° C. in order to gain insight with regard to the effect of surface temperature. To test the activity suppression capabilities of the overcoating layer, the degradation kinetics of stearic acid were tested: a 5 mg/mL stearic acid solution in methanol was deposited and spun twice at 2500 rpm for 2 min. All plates were then individually placed at a distance of 15 cm under a Blak-Ray® 100 W, 365 nm UV lamp for 40 min, with measurements taken every 10 min. The kinetics were deduced by monitoring changes in the IR absorption CH₂(a) peak at 2916 cm⁻¹.

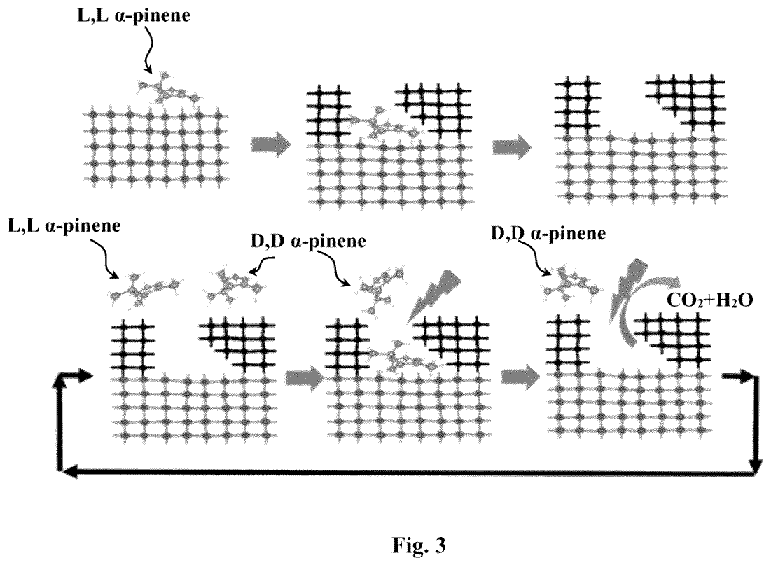

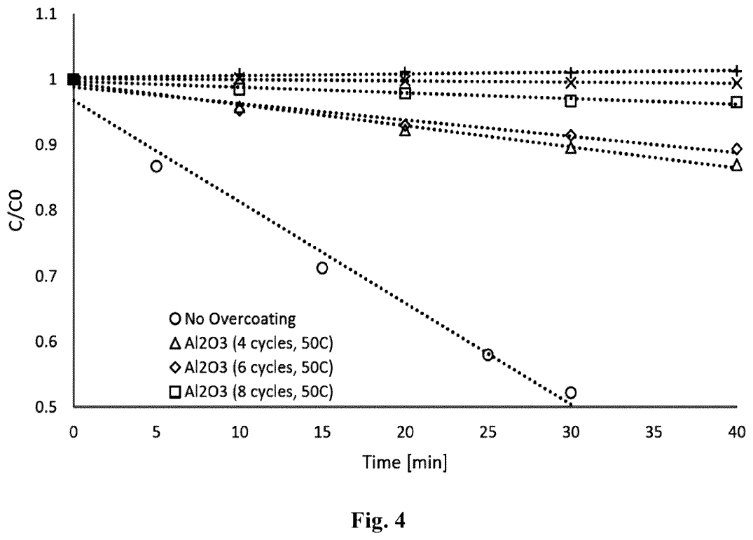

FIG. 4 shows the normalized concentration of stearic acid measured for each plate throughout the reaction. FIG. 4 clearly shows that increasing the thickness of the overcoating layer (from 4 cycles of atomic layer deposition of alumina to 12 cycles) reduces the photocatalytic activity and indicates that 4-12 atomic layers can be regarded as an adequate range for blocking the activity of the said photocatalyst. The results are also given in a tabulated manner in Table 1.

TABLE 1
Relative photocatalytic activity of photocatalytic
films, overcoated with ultrathinlayers of alumina,
as inferred based on the degradation of stearic acid

| | Temperature | Al₂O₃ layer | Activity relative |
|---|---|---|---|
| Cycles | (° C.) | thickness (Å)* | to nude TiO₂ (%) |
| 4 | 50 | 6 | 20.65 |
| 6 | 50 | 8 | 16.13 |
| 8 | 50 | 10 | 5.81 |
| 8 | 60 | 10 | 1.29 |
| 12 | 50 | 15 | 0 |

*estimated

This example demonstrates how ultrathin layers of an oxide (alumina) in the thickness between 4-12 atomic layers act to reduce the photoactivity of titanium dioxide films. The example further demonstrates how altering the temperature during the overcoating process affects the properties of the overcoating, in a manner that influences its ability to prevent photocatalytic reaction at the surface.

### B. Templating and Characterization

Photocatalytic units (to be also referred to hereinbelow as PEDs) comprised of thick TiO₂ films on 25 mm×12.5 mm glass slides, overcoated with Al₂O₃, were prepared by the following procedure. Glass microscope slides (Marienfield) were cleaned by washing in chloroform, ethanol, and deionized water. A mixture of 9.2 g of P25 titania powder (Degussa) and 0.6 g of X-500 titania suspension (TiPE Ltd.) in 12 ml of deionized water was thoroughly (15 min) sonicated (MRC, DC80H) and applied on the glass substrates using the doctor blade method. The deposited thick films (15 μm) were then calcined at 450° C. for 5.5 h to improve adhesion. Next, 300 μl of a 0.25 mg/ml solution of either L-LeuGly (Sigma-Aldrich) or D-LeuGly (Santa Cruz Biotechnology) in deionized water was administered on each of the imprinting-designated slides and spun at 4000 rpm for 80 sec. Part of the TiO₂-coated slides, termed as (−,−), were left aside without LeuGly. All of the LeuGly-containing plates and half of the (−,−) slides were overcoated with 10 cycles of Al₂O₃ ALD, according to the procedure described above. Here, the deposition temperature for all PEDs was 50° C. Finally, the alumina-overcoated plates were UV-ozone cleaned for 15 min (UVOCS® Ltd.) to remove the templating molecules prior to reaction.

The prepared PEDs were divided into four groups: non-overcoated non-templated plates denoted as (−,−), overcoated non-templated plates denoted as (+,−), overcoated L-templated plates (+,L) and overcoated D-templated plates (+,D). The photocatalytic thick film and overcoating aluminum oxide layers were analyzed using XRD (Rigaku, MiniFlex II), XPS (Thermo VG Scientific, Sigma Probe), and SEM+EDS (Zeiss, Ultra-Plus HRSEM).

Additional ultrahigh-resolution AFM measurements were carried out on PEDs prepared using the same sol-gel procedure used in Activity Suppression. Here, the same templating procedure described above for the P25-containing slides (spin-coating with the templating molecules followed by 10 ALD cycles of Al₂O₃) was performed. One additional sample was made with a templating solution containing 0.5 mg/mL of L-LeuGly rather than the 0.25 mg/mL used elsewhere. This type of PED was chosen, as its corrugation is significantly lower than that of the P25-based PEDs. During the AFM measurements of these samples, the plates were first cleaned for 5 min with oxygen plasma and their surface was wetted with a 0.1 M NaCl solution to remove air pockets. This was followed by a quasi-static 4 h stage approach to minimize signal drift, in an ultrahigh-resolution AFM setup.

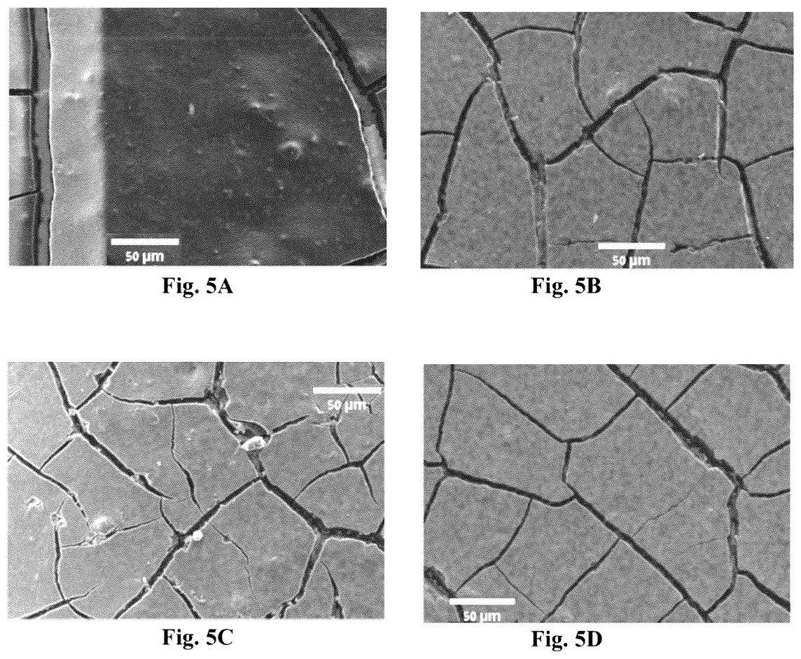

The XRD pattern was typical for P25 TiO₂ (i.e. a mixture of anatase and rutile), as the alumina layers were too thin to have any diffraction effect (not shown). The SEM-EDS images (FIGS. 5A-5D) revealed the presence of aluminum atoms at the surface, in quite a homogeneous distribution. The relative amount of aluminum increased upon increasing the number of ALD growth cycles. It should be noted that all samples, regardless of whether or not they had been overcoated, displayed cracks on their surface (all the way to the glass substrates); however, these cracks are not considered to be a challenge for ALD coating, which is well-suited for irregular, high-aspect-ratio topography.

Table 2 presents the atomic concentration (%), as measured by XPS, of PEDs that had been prepared using imprinting solutions of different concentrations of LeuGly (0, 0.1, 0.5, and 1 mg/mL). In all samples the overcoating layer was prepared by 10 ALD cycles of alumina. All measurements were performed prior to stripping the templating LeuGly.

TABLE 2
XPS Atomic Concentration (%) of Oxygen, Carbon,
Titanium, Aluminum and Nitrogen atoms in PEDs
Overcoated with 10 ALD Cycles and Templated with
0, 0.1, 0.5, and 1 mg/mL Solutions of L-LeuGly

Atom %

| | 0 mg/ml | 0.1 mg/ml | 0.5 mg/ml | 1 mg/ml |
|---|---|---|---|---|
| O 1s | 55.8 | 57.6 | 58.3 | 51.6 |
| C 1s | 19.9 | 18.4 | 16.7 | 30.4 |
| Ti 2p3 | 13.5 | 14.1 | 13.8 | 7.7 |
| Al 2p | 10.8 | 9.8 | 10.9 | 9.8 |
| N 1s | ~0 | 0.2 | 0.3 | 0.4 |

The concentration of oxygen was found to be 56±3%. On a free-carbon basis, the atomic concentration of oxygen was 71%. The atomic concentration of carbon was found to be 18±1% for samples prepared with a low concentration of imprinting molecules. Without wishing to be bound by theory, the high atomic concentration of carbon measured in samples prepared with a high concentration of LeuGly suggests that the templating molecules tend to be deposited as aggregates under this condition during preparation. These aggregates may act to ease the further adsorption of organic contaminants. The conclusion regarding the presence of aggregates in samples prepared with the highest concentration of LeuGly is further supported by the low atomic concentration of Ti found in such samples.

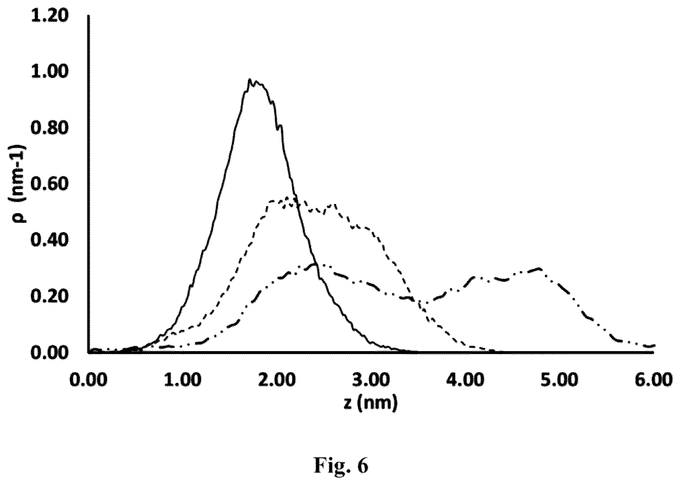

Ultrahigh-resolution AFM measurements were performed on PEDs and on nonimprinted titania films overcoated with alumina (10 ALD cycles), in order to verify the presence of molecular cavities in the PEDs. A plot of the distribution (ρ) of heights (z) relative to the minimum of each frame, as shown in FIG. 6, a clear difference between the two devices was revealed. Here, the height distribution of the coated, nonimprinted film (denoted (+,−)) peaked at around 2 nm, in a Gaussian manner. In contrast, the height distribution of the imprinted PEDs was considerably wider and could be resolved into two, partially overlapping, distributions: one that was very similar to that of the (+,−) sample and a second that peaked at around a height of 3 nm. The same effect was even more distinct for the plate prepared with the higher templating molecule concentration, resulting in a bimodal distribution peaking at 2.5 nm and at 4.5 nm. Hence, it may be concluded that the overcoating process did not bridge over the templating molecules, resulting in the formation of molecular cavities on the surface of the PEDs. It should be noted that the data presented in FIG. 6 was determined on the basis of 16000 points (50 nm×50 nm) and hence is definitely statistically significant.

### C. Single-Enantiomer Kinetics

The photocatalytic degradation kinetics of each enantiomer was performed in a reaction vessel comprised of a perforated-bottom 50 mL beaker in which one photocatalytic plate was placed in each experiment. The perforated beaker was introduced into a larger beaker containing a stirring bar, allowing continuous mixing of the solution during the reaction. A glass cover was used to minimize evaporation.

All tests were conducted with 100 mL of an aqueous solution (0.5 mg/mL) of enantiomerically pure (L or D) LeuGly. The photocatalytic plate was placed 15 cm below a Black-Ray® 100 W 365 nm lamp, following adsorption in the dark for 20 h. Each plate was used twice: first with one enantiomer and then with the second. The concentration of the peptide in solution was determined using a previously developed fluorometric assay with the fluorescent taggant molecule fluorescamine, a method that is enantiomerically blind. The results were fit to an apparent first-order mechanism.

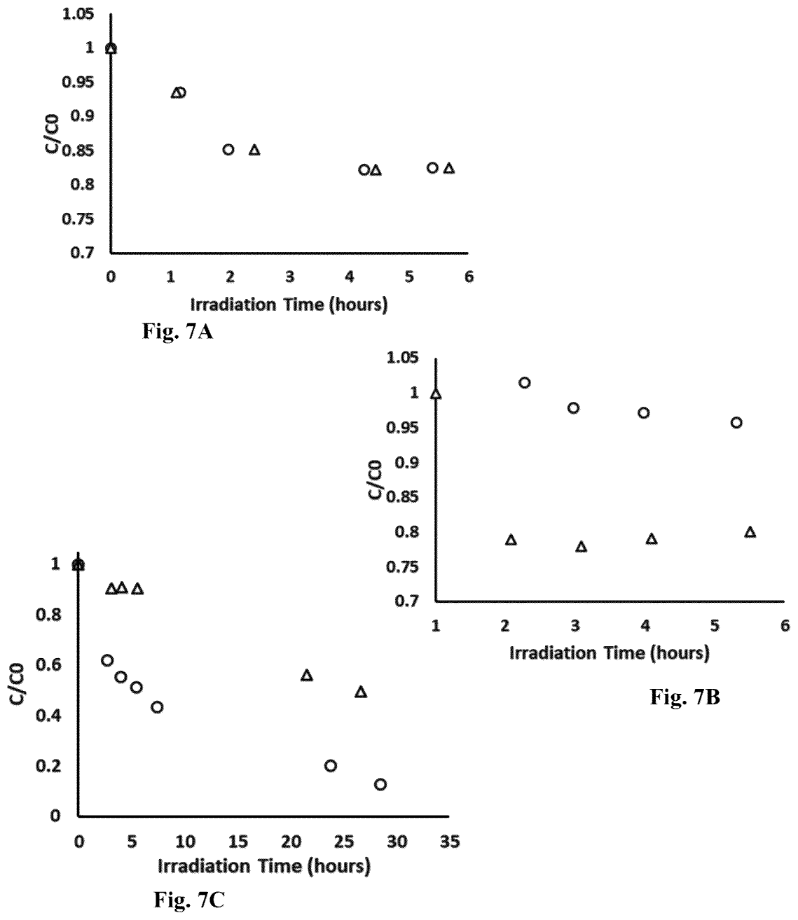

As an initial test of the PEDs, the photocatalytic degradation kinetics of the L-enantiomer of LeuGly was compared with that of the D-enantiomer in an enantiopure solution. This was done both with PEDs and with nonimprinted, non-coated TiO₂ films. All PEDs reported in this and in the following sections of this Example were overcoated with a 10-cycle ALD layer. This thickness was found to yield higher selectivity in comparison to that obtained with imprinted PEDs having thinner layers. As shown in FIG. 7A, the degradation kinetics of the L-enantiomer were virtually identical with those of the D-enantiomer on nonimprinted substrates. In contrast, the degradation kinetics of the L-enantiomer were many times faster than those of the D-enantiomer on L-imprinted PEDs (FIG. 7B). In a symmetrical manner, the degradation kinetics of the D-enantiomer were significantly faster than those of the L-enantiomer on D-imprinted PEDs (FIG. 7C).

To quantify this apparent selectivity effect, the kinetics were fit to a first-order rate law (Table 3). As portrayed in Table 3, in the absence of imprinted cavities, the rate constant for the degradation of the L-enantiomer was almost identical with the rate constant measured for the D-enantiomer. This was not the case with the coated, imprinted PEDs. The rate constant of the L-enantiomer was significantly higher than that of the D-enantiomer upon using L-imprinted PEDs. The opposite was observed upon degrading LeuGly in the presence of D-imprinted PEDs.

TABLE 3
First-order rate constants and L-enantiomer selectivity of the
single-enantiomer experiment (kᵢ = degradation kinetic constant)

| Plate type | k_{L} (1/h) | k_{D} (1/h) |
|---|---|---|
| (−, −) | 0.0341 | 0.035 |
| (+, L) | 0.0391 | 0.0107 |
| (+, D) | 0.007 | 0.0624 |

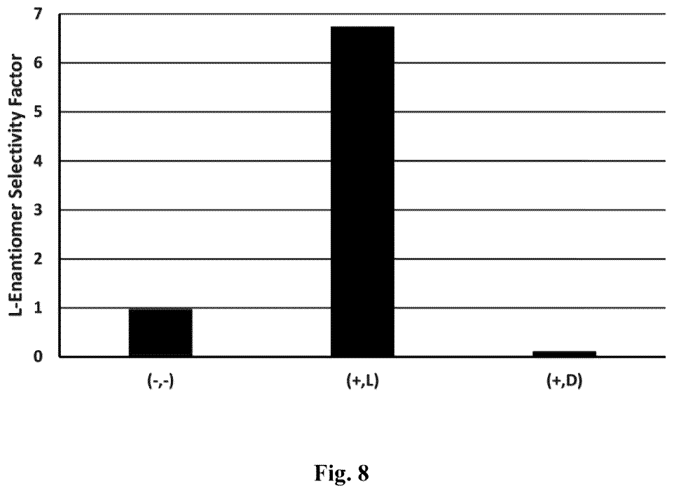

The ratios between the rate constants in the degradation of L-enantiomer to those of the D-enantiomer for the three cases are presented in FIG. 8. The differences in the kinetics of the degradation of the D- and L-enantiomers for the imprinted PEDs are striking. While both types of templates led to preferential degradation of the corresponding enantiomer, the effect of imprinting the D-enantiomer was larger than that of imprinting the L-enantiomer (9.1 vs 6.7). A second run maintained the enhanced selectivity for the imprinted species.

### D. Racemate Kinetics and Enantiomeric Enrichment

A set of reactions with racemic mixtures as reactants was carried out in a Radleys 12-vial parallel reaction system modified with 12 intensity-tuned, voltage-controlled 365 nm LEDs, allowing direct illumination of the vertical plates without interfering with stirring. This system is denoted as “the carousel system”. All vials were simultaneously illuminated following an adsorption equilibrium and were monitored in parallel. Some tests were also performed in the same reactor used for the single-enantiomer kinetics studies. To quantify the concentration of each enantiomer, a chiral-resolving method was developed for an Agilent 1100 HPLC instrument. An Astec Chirobiotic T (4.6 mm×15 cm) chiral column, with an isocratic mobile phase of 70% (by volume) methanol and 30% 50 mM triethylamine acetate (TEAA) in water at a pH of approximately 6.75, was used. The flow rate was 0.4 mL/min, and the temperature was set to 20° C. The run time was 10 min, during which the L-enantiomer was the first to elute at 7 min, while the D-enantiomer eluted 30 sec later. For all measurements the resolution factors were larger than 2.

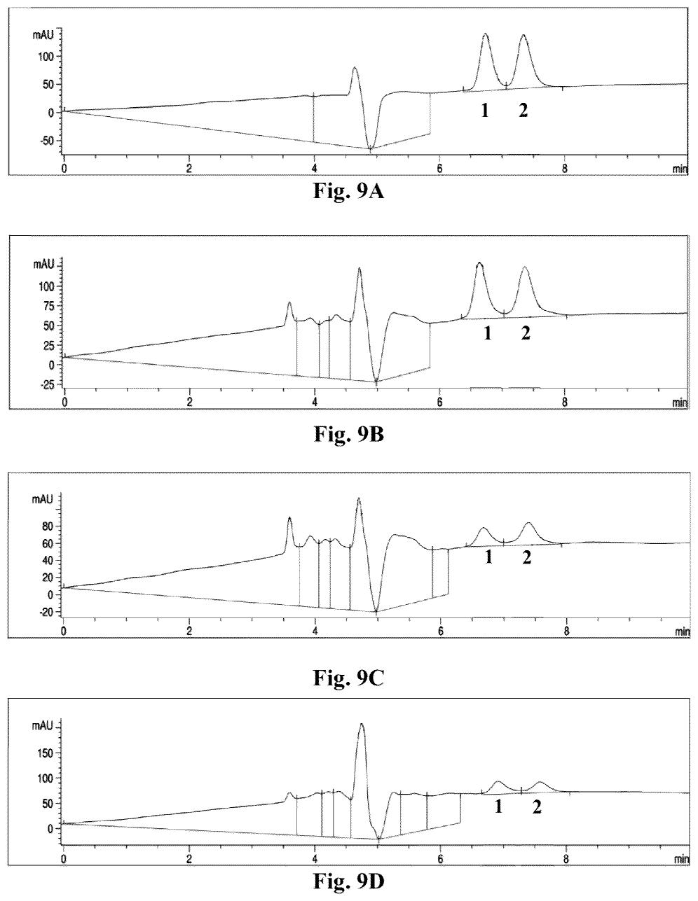

After assessing the kinetic differences between the enantiomers in separate reactions, we conducted the ultimate selectivity test—enriching an initially racemic solution by preferential degradation of the templating enantiomer. FIGS. 9A-9D present a typical chromatogram of a racemic LeuGly solution, showing the characteristic, well-resolved peaks of the L-enantiomer (1) and the D-enantiomer (2). As can be seen, the initially racemic solution (FIG. 9A) maintained a constant ratio of the L- and D-enantiomers and low degradation rates throughout the reaction carried out on the coated, nonimprinted PED (FIG. 9B). The reactions carried out on the imprinted PEDs, however, resulted in both a dramatic increase of the degradation rates and an uneven reaction progress, with the templated enantiomer (the distomer) being degraded more quickly than its counterpart (FIGS. 9C-9D).

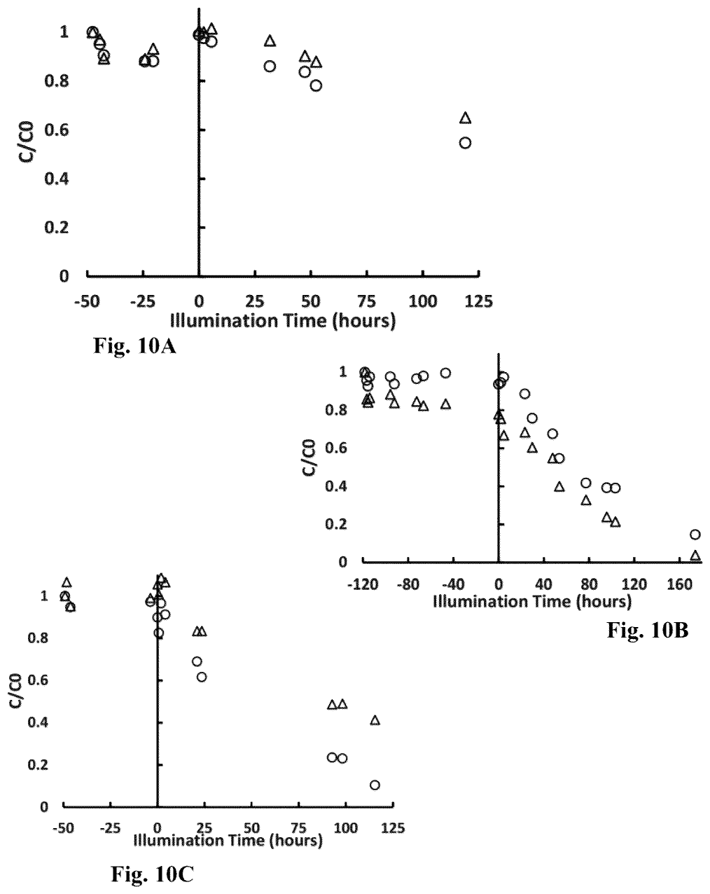

FIGS. 10A-10C show the concentration of each enantiomer in the racemic mixture, during the dark adsorption stage (negative times) and the subsequent kinetics during illumination of the PEDs. Regardless of the chirality of the templating species, the imprinted PEDs revealed an increased adsorption affinity toward their corresponding distomer (FIGS. 10B-10C), whereas the nonimprinted control device did not exhibit any preference (FIG. 10A). This trend also remained during the illumination stage, in which the molecules were photo-catalytically degraded. It should be noted that non-negligible degradation of both enantiomers was measured for the coated, nonimprinted devices (FIG. 10A). Since the direct photolysis of LeuGly is insignificant on these time scales (as determined in an additional control test), this suggests that the thickness (or conformality) of the alumina overcoating is less than perfect and can be optimized in a manner that may further increase the enrichment performance of the PEDs. Comparing the kinetics of the eutomers (the D-enantiomer in the L-imprinted PED and the L-enantiomer in the D-imprinted PED) to that of the coated, nonimprinted PED reveals faster degradation kinetics on the imprinted units. This implies that degradation of the eutomers on the imprinted PEDs occurred within the imprinted cavities.

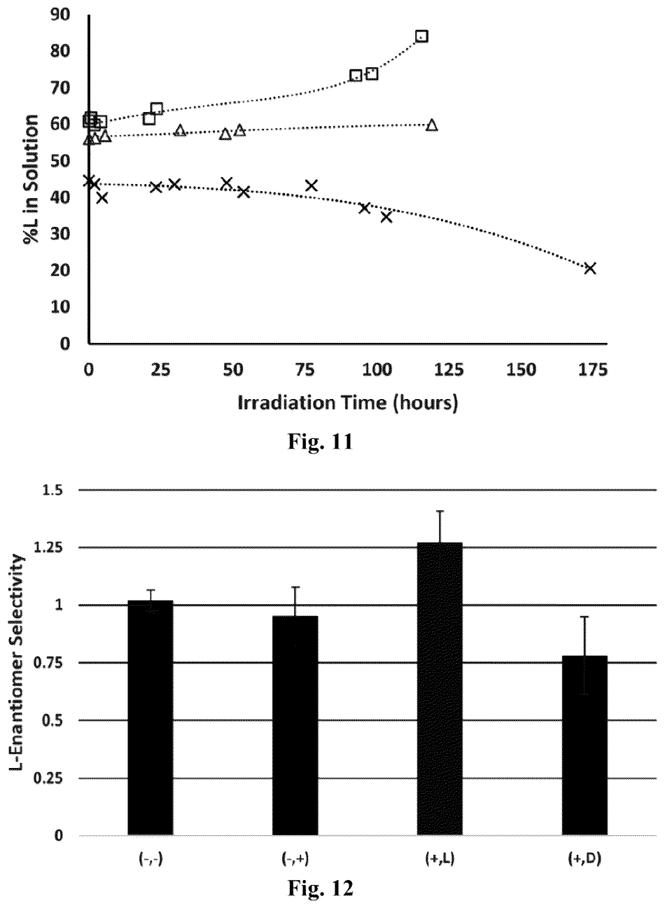

The preferential adsorption and photocatalytic degradation kinetics are best represented in the form of enrichment curves (FIG. 11), displaying the relative concentration of the L-enantiomer in the three different types of devices (L-imprinted, D-imprinted, and nonimprinted) during illumination. Here, an increase in the concentration of the eutomers is clearly observed for both imprinting chiralities. A comparison between D-imprinting and L-imprinting reveals a quasi-symmetrical behavior, with a slight native tendency toward degradation of the D-enantiomer. Sharp-eyed readers may notice that the zero-time ratios between the L- and D-enantiomers are different from 1. This reflects the preferential selectivity during the “dark” adsorption stage.

FIG. 12 presents the averaged L-enantiomer selectivity factor (i.e. k_{L}/k_{D}), obtained upon repeating the set of measurements also in the carousel system described above, with four types of plates. As previously discussed, this ratio is higher than 1 for the L-imprinted and coated PEDs (1.27±0.1) and lower than 1 for the D-imprinted and coated PEDs (0.78±0.1). The selectivity factor was very close to unity in the absence of imprinting, for both the coated and noncoated samples.

From a practical point of view, successful implementation may require time scales significantly shorter than the typical reaction times reported above. In this context, it should be noted that the use of photocatalytic PEDs in the form of powders is expected to dramatically increase the rates, thus shortening the required reaction time. When a surface area of 50 m²g⁻¹ for the powder is taken into account, a conservative calculation gives an estimated rate increase of at least 1 order of magnitude.

### Example 2—Imprinted Titanium Dioxide Particles

### A. Preparation of Imprinted Photocatalyst Made of Titanium Dioxide

5.87 ml (0.0075 mol) of titanyl sulfate (15% wt in H₂SO₄) and 1.3 ml HCl (37% wt in H₂O) were added to 243 ml of deionized water in a 500 ml round flask. The solution was stirred for 1 hour at room temperatures. 5 ml of NH₄OH (25% wt in H₂O) were then added to the mixture to stabilize the pH at ˜1.3. The flask was connected to a reflux condenser and heated to 60° C. for 24 h in a silicon oil bath. After 20 h of reflux, 35.5 mg of L-Leucyl-glycine (L-LG) were added. The obtained white colloidal solution was vacuum-filtered and washed with ˜100 ml deionized water. The solids were dried in a drying rack at 60° C. for 50 hrs. The dried off-white powder (total weight 733 mg) was crushed and stored.

### B. Overcoating

A 5.5″ diameter, 15 Ohm loudspeaker was fit with a triggering system set to operate at a frequency of ˜15 Hz upon activation of an attached electrical timer, at a set time. The circuit was operated using four AA batteries, and an additional 3V battery for the timer. A containment device was made using a screw-top polypropylene wafer jar with five round 1 cm holes bored in the top, and fitted with 10 μm pore PTFE frits. 254 mg of the titanium dioxide powder obtained in step A was placed inside the containment device, and placed on top of the speaker membrane. This setup was placed in an MVD100E molecular vapor deposition system operating to grow the overcoating layer by Atomic Layer Deposition (ALD). The timer was set to the planned time of operation, and the system was vacuumed for 16 hrs, to a pressure below 1 mTorr. Upon starting of operation, the system was heated to 60° C., and a cycle was started consisting of 1 Torr of trimethylaluminum (TMA) gas followed by vacuuming to 20 mTorr, followed by 5 purge cycles of 99.9999% nitrogen gas and vacuuming to 20 mTorr, followed by 1 Torr water vapor, followed by vacuuming to 20 mTorr, followed by 10 purge cycles of 99.9999% nitrogen gas and vacuuming to 20 mTorr. This complete cycle was repeated 16 times. The chamber was vented and the setup was removed. The result was about 50 mg of powder, which was stored.

### C. Removal of Imprinted Molecules

The powder was exposed to UV-ozone in a commercial system (UVOCS®) for 10 min, mixed, and re-exposed for another 10 min.

D. Introduction of Photocatalyst into an Enantiomeric Mixture

A solution containing 50 mg of L-LG and 50 mg of a second enantiomer, D-LG, was prepared in 50 ml deionized water, inside a 200 ml beaker covered with a glass petri dish. In this solution, 50 mg of the catalyst powder were suspended and stirred in the dark for 24 h.

### E. Exposure of the Medium to Light

A pair of Osram Eversun L40W/79K, 40W, max emission at 355 nm were located 15 cm from the vessel containing the solution prepared in part D. 0.9 ml samples were taken periodically throughout the reaction, centrifuged at 10000 RPM for 10 min, with the supernatant liquid split into two samples, one 0.025 ml sample diluted by a factor of using 0.475 ml deionized water, and the other diluted by a factor of 2 in 0.2M, pH 7 phosphate buffer solution in deionized water.

### F. Analysis of Enantiomeric Enrichment

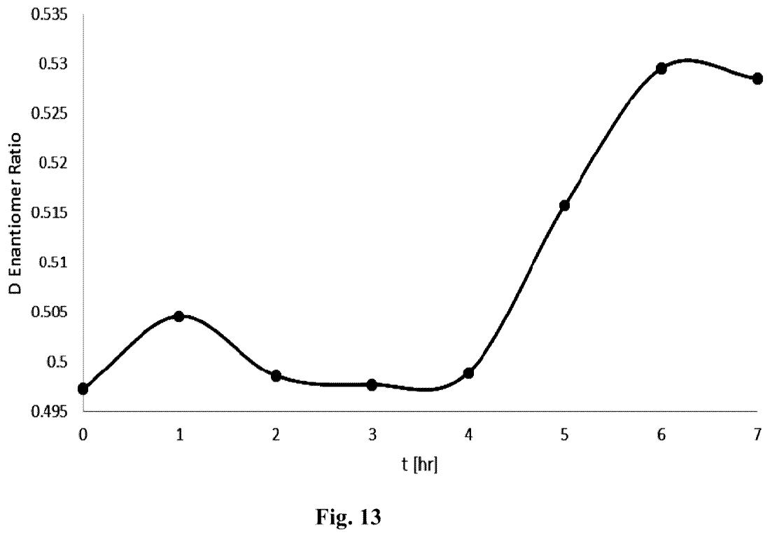

The sample diluted by the factor of 20 was then mixed with 1 ml of 0.2 M, pH 7 phosphate buffer solution in deionized water and 0.5 ml of a 0.15 mg/ml solution of fluorescamine in acetone, and each sample was placed in four separate wells in a black 96-well fluorescence reading plate. The fluorescence reading was measured in a Tecan plate reader, with excitation at 390 nm and emission measured at 470 nm, gain at 95%, and the total LG concentration, of both enantiomers, was calculated using a premade calibration curve, using the average value of the four readings. The sample diluted by a factor of 2 was taken as is and measured using circular dichroism in a PiStar circular dichroism spectrophotometer, where initially a phosphate buffer's spectrum was measured between 300 nm and 190 nm as a baseline, and these values were subtracted from all other measurements. A calibration curve was made using different ratios of the L- and D-LG enantiomers at total concentrations similar to those measured using the fluorimetry method described above. The samples were then measured, and their enantiomeric ratio assessed, each measured three times and averaged. FIG. 13 shows the measured relative part of the D-enantiomer in the solution throughout the reaction.

This example shows a clear trend of increasing the enantiopurity (defined herein as D/(D+L)) with increasing reaction time. Hence, exemplifies the ability of an embodiment made of imprinted titanium dioxide particles, where each particle is overcoated with 16 atomic layers of alumina to enrich the relative concentration of the enantiomer that had not been imprinted upon exposing the said particles to UV light.

### Example 3

The efficacy of the adsorption of a specific enantiomer on the surface of a photocatalyst film, following by overcoating the photocatalyst around the adsorbed molecules, thus forming enantiomeric cavities in the inert layer, where the cavities were formed within the photocatalyst, is demonstrated in this example.

### A. Preparation of a Photocatalyst Film Made of Titanium Dioxide Coated Plates

9.2 g of a commercially available TiO₂ powder (Degussa P25) and 0.6 ml of X-500 suspension were mixed with 12 ml deionized water, and sonicated for 30 min in an ultrasonic bath. Glass microscope slides were cut into 1″×0.75″ pieces, and cleaned with ethanol, then chloroform. These were fixed on two parallel sides to a clean working surface using sticky tape, leaving a total unobstructed area of 0.75″×0.75″. On this area, the P25 mixture was applied in a uniform layer of a thickness on the scale of the piece of tape (approximately 15 micrometer). The coated plates were then calcined for 5.5 h in air at 450° C. in a tubular furnace, the heating rate being 25°/min.

### B. Adsorption of the Target Enantiomer

Two solutions, one of 1 mg/ml L-LG in ethanol and the other of 1 mg/ml D-LG in ethanol, were made, and further used to make two 0.25 mg/ml solutions, one of each enantiomer, through dilution with ethanol by a factor of 4. 0.3 ml of the solution of the lower concentration of L-LG were deposited separately on 4 plates and spin-coated for 80 sec at 4000 RPM. Similarly, 0.3 ml of the low concentration solution of D-LG were deposited on 4 different plates and spin-coated for 80 sec at 4000 RPM. The plates were retrieved completely dry, and stored. 4 more plates were stored without adsorption of LG molecules.

### C. Overcoating

The imprinted and non-imprinted plates were overcoated with 8 cycles of TMA and water in the MVD100E system as described in Example 1. Other samples, prepared in the same manner described in stage (a), but without adsorbing the imprinting molecules, were also coated in the same manner. These samples were used as reference samples, to verify the effect of imprinting.

### D. Removal of Imprinted Molecules

The plates placed with the imprinted and overcoated side facing upwards. Then they were exposed to UV-ozone in a commercial apparatus (UVOCS®) for 15 min.

E. Introduction of Photocatalyst into an Enantiomeric Mixture

Each tested plate was placed in a different beaker. A solution of 50 mg L-LG and 50 mg D-LG in 100 ml deionized water was prepared for each sample. Then, both beakers were covered with a glass petridish and stirred in the dark for 48 hrs.

### F. Exposure of the Medium to Light

Both beakers were exposed to a Black-Ray® 100W, 365 nm UV light source located 15 cm from the solution. 0.3 ml samples were taken periodically and refrigerated until analysis. The same procedure was performed with the reference samples.

### G. Analysis of Enantiomeric Enrichment

The samples were placed in HPLC vials, and tested in an Agilent 1100 HPLC, fit with a quaternary pump and an Astec Chirobiotic-T 10 cm×4.2 mm chiral stationary phase column. The analysis was carried out isocratically, with the following parameters: 70% methanol and 30% of 50 mM triethylammonium acetate buffer in water with pH in the range of 6.5-7.0, column temperature at 20° C., injection volume of 5 μl, flow rate of 0.4 ml/min, with the chromatograms obtained at 254 nm (control), 210 nm (working wavelength) and 206 nm (additional control). The total running time of the program was 10 min, with the L-LG peak appearing at 7 min and the D-LG appearing at 7.5 min. After each run, a cleaning sequence was initiated, consisting of 70% methanol and 30% 50 mM triethylammonium acetate buffer in water with pH in the range of 6.5-7.0, column temperature at 20° C., injection volume of 5 μl of pure methanol, flow rate of 1 ml/min, for a total of 7 min. Each time a new buffer was made, a new calibration curve was made for the two different enantiomers.

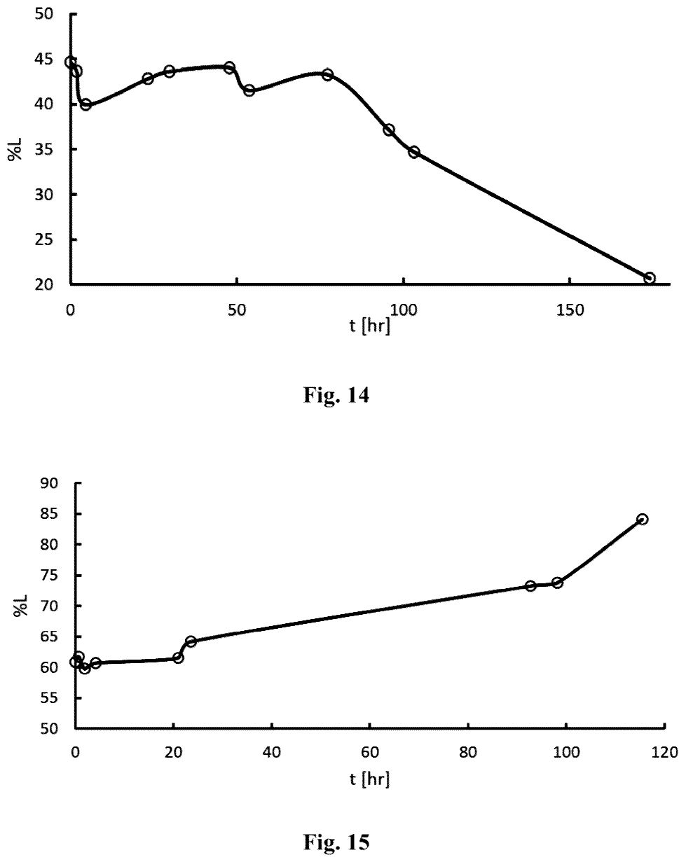

FIG. 14 shows the measured enantiomeric ratio of the L-enantiomer in the solution (i.e. L/(L+D)) as a function of exposure time. The figure clearly shows that over-coating the photocatalyst onto which the L-enantiomer was adsorbed with a thin layer of inert coating, thus forming L-type cavities in contact with the photocatalyst increased the relative rate of degradation of the L-type enantiomer, such that its relative concentration decreased over time, i.e. the concentration of the D-enantiomer was enriched. A complementary result is portrayed in FIG. 15. Here, the cavities that were prepared had the D-enantiomer shape, hence its degradation was faster, leading to enrichment of the L-enantiomer in the solution. The degradation kinetics were found to obey a first order behavior. The apparent reaction rate constants, including those obtained with the non-imprinted samples, are presented in Table 4. The table further presents the selectivity ratio in terms of k(D-LG)/k(L-LG). While the ratio between the rate constant in degrading the D-enantiomer to that of degrading the L-enantiomer was 1.36 without imprinting, this ratio increased to 2.04 upon imprinting the D-enantiomer. In parallel, the ratio was reduced to 0.67 when the L-enantiomer was imprinted.

TABLE 4
The reaction rate constant in the photocatalytic degradation of
D-LG and L-LG using threetypes of P25 TiO₂ films: (1) overcoated
with 8 atomic layers of alumina (2) overcoated with 8 atomic
layers of alumina following adsorption of L-LG (3) overcoated
with 8 atomic layers of alumina following adsorption of D-LG

| | Non-imprinted | L-imprinted | D-imprinted |
|---|---|---|---|
| | overcoated | overcoated | overcoated |
| | plate | plate | plate |
| D-enantiomer k_{D} | 0.0049 | 0.0107 | 0.0165 |
| (1/h) | | | |
| L-enantiomer k_{L} | 0.0036 | 0.0159 | 0.0081 |
| (1/h) | | | |
| Selectivity (k_{D}/k_{L}) | 1.36 | 0.67 | 2.04 |
| Activity damping | — | Total 3.1 | Total 2.9 |
| | | L 4.4 | L 2.3 |
| | | D 2.2 | D 3.4 |

kᵢ = kinetic constant of enantiomer i

This example demonstrates the efficacy of an embodiment based on the absorption of a specific enantiomer on the surface of a photocatalyst film, following by overcoating the photocatalyst around the adsorbed molecules, thus forming enantiomeric cavities in the inert layer. This is shown in a complementary manner, i.e. for both cases: upon imprinting D-type and upon imprinting L-type. Hence, example 3 demonstrates the efficacy of several different embodiments described in the detailed description above: Imprinting on a film rather than on particles, imprinting in the inert layer rather than in the photocatalyst and the effect of two different imprinting species.

### Example 4

### A. Preparation of a Photocatalyst Film Made of Titanium Dioxide Coated Plates

A suspension of 239 g/L of Degussa P25 particles was made in deionized water. Additionally, a suspension of 30.19 ml of triethyl orthosilicate (TEOS), 46.24 ml of LUDOX silicon dioxide suspension, 0.714 ml of HCl (37% wt in H₂O) and 136 ml of isopropanol was made. Then, 3.04 ml of the P25 suspension, 4.9 ml of the TEOS-LUDOX suspension and 2 ml of n-propanol were stirred for 10 min and then sonicated for 10 min. Glass microscope slides were cut into 0.75″×0.5″ pieces, and cleaned with ethanol, then chloroform. On these, 0.15 ml of the TiO₂/SiO₂ mixture was spin-coated at 4000 RPM for 30 sec, followed by annealing for 30 min in a furnace that was pre-heated to 150° C. Then, a second layer was formed by spin-coating 0.12 ml of the TiO₂/SiO₂ mixture at 2000 RPM for 30 sec and annealing at 150° C. for 30 min. A new TiO₂/SiO₂ suspension was made, this time with 3.04 ml of the P25 suspension, 4.9 ml of the TEOS-LUDOX mixture and 1.5 ml of n-propanol, stirred for 10 min and then sonicated for 10 min. From this suspension, 0.1 ml was spin-coated on each plate at 1500 RPM for 30 sec, followed by annealing at 150° C. for 30 min, thus forming a third layer. Then, a fourth layer, made by spin coating another 0.1 ml of the suspension on each plate at 1500 RPM for 30 sec, following by annealing at 150° C. for 30 min was grown.

### B. Adsorption of the Target Enantiomer

Two solutions, one of 0.25 mg/L of L-LG in DIW and the other of 0.25 mg/L D-LG in deionized water, were prepared. 0.2 ml of the L-LG solution was spin coated on 6 of the prepared plates at 4000 RPM for 90 sec. Then, 0.2 ml of the D-LG solution was spin coated at 4000 RPM for 90 sec on another 6 of the prepared plates. 10 more plates were left without templating.

### C. Overcoating

Two plates coated with L-LG, two plates coated with D-LG and two plates with no adsorbed molecules were overcoated with 6 cycles of TMA and water as described in example 1. Similarly, two plates of each described type were coated with 10 and 14 cycles of TMA and water. 4 plates were left without overcoating.

### Example 5

This example shows the characterization of the thickness of the ALD-grown overcoating layer after 10 cycles, as ALD growth models usually describe significantly thicker layers.

### A. Preparation of an Imprinted Alumina Layer on a Silicon Wafer

A silicon wafer was cut into pieces, UVOCS® cleaned, and deposited with 600 μl of an 0.25 mg/ml L-LeuGly solution via spin-coating at 1000 RPM for 2 min, followed by 10 cycles of ALD as described in previous examples. The wafer was then coated with 30 nm of graphite by thermal evaporation followed by 100 nm of chrome by sputtering in order to protect the structure from radiation damage, and was cut into a lamella using FIB. The lamella was imaged using HR-STEM coupled to EDS elemental analysis.

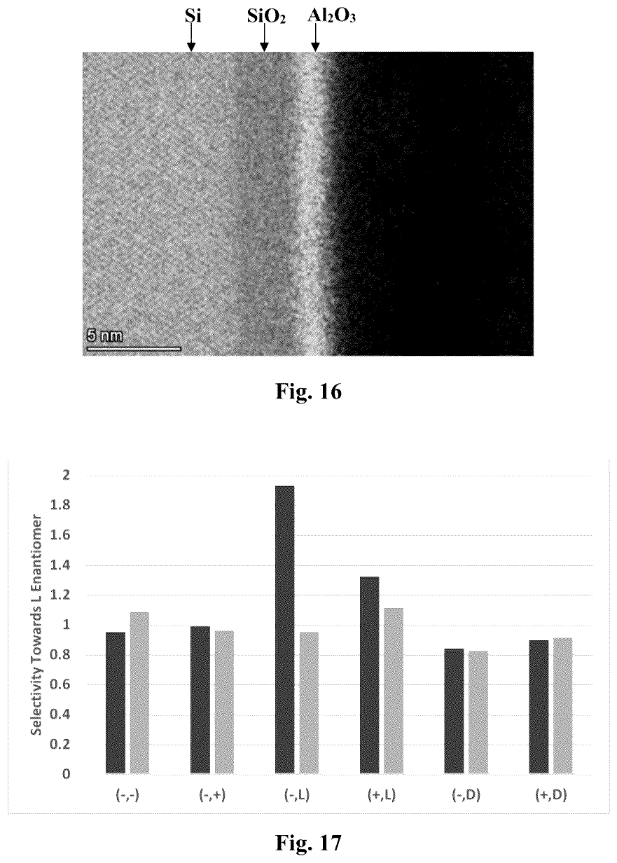

FIG. 16 shows the existence of a thin alumina layer on top of the native oxide present on the wafer's surface, measuring 1.8 nm in thickness, corresponding to the pore depths measured using AFM.

### Example 6

### A. Preparation of the Matrix-Imprinted Photocatalyst Made of BiOCl:

A Bi⁺³ stock solution was made by dissolving Bi(NO₃)₃·5H₂O in ethylene glycol (48.52 gr/lit), and Cl⁻ stock solution was made by dissolving KCl in deionized water (DIW) (7.441 gr/lit). Both were stirred overnight at room temperature to obtain homogenous solutions. For each batch, 150 ml the Bi⁺³ solution was placed under stirring in an Erlenmeyer, followed by the slow addition of 150 ml of the KCl solution under stirring to obtain a milky suspension. To samples where matrix-imprinting was performed, either L-LeuGly or D-LeuGly were added in a 1:20 LeuGly:Bi molar ratio (˜145 mg in 300 ml). Reaction commenced for 24 hrs, after which the sample was filtered, washed and dried at 60° C.

B. Preparation of Photocatalyst Films Made from Matrix-Imprinted BiOCl in a Silica Binder

The dried powders were suspended in deionized water at a concentration of 240 mg/ml, sonicated for 5 min, followed by overnight stirring. For better adhesion to the silica substrates, an SiO₂ binder suspension was made by sequentially mixing, in a dropwise manner, TEOS, LUDOX colloidal suspension, 37% HCl and isopropanol in a 1.42:2.17:0.034:6.38 volumetric ratio. This suspension was also stirred overnight. The BiOCl suspension was mixed into the TEOS suspension, followed by the addition of n-propanol in a 1:1.612:0.493 volumetric ratio, and thoroughly sonicated for 5 min. This suspension was then deposited using spin-coating on precut 1″×0.5″ fused silica plates, precleaned with ethanol, acetone and water followed by 5 min UVOCS cleaning. 150 μl was deposited on each plate, and spun for 30 sec at 2000 RPM, followed by overnight drying at 60° C. An additional layer was deposited in a similar fashion, for a total of two layers.

### C. Overcoating

Some of these plates were then sent for 10 cycles of Al₂O₃ ALD overcoating using the same procedure described in previous examples.

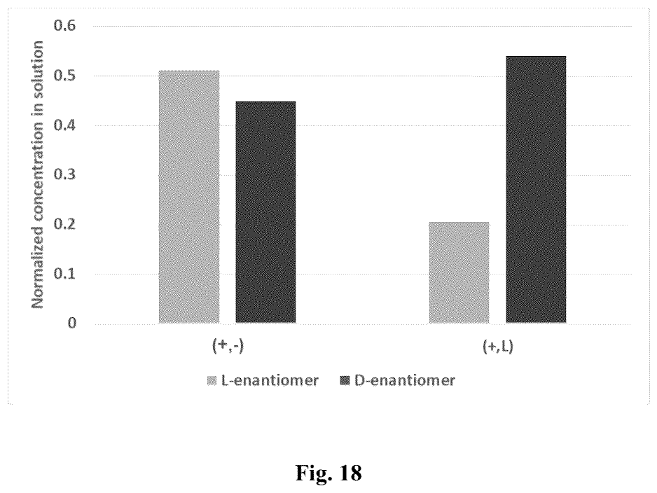

FIG. 17 shows the L-enantiomer selectivity factors (k_{L}/k_{D}) for films BiOCl in an SiO₂ binder with no overcoating and no imprinting (−,−), 10 cycle overcoating and no imprinting (+,−), no overcoating and L-imprinting (−,L), 10 cycle overcoating and L-imprinting (+,L), no overcoating and D-imprinting (−,D), 10 cycle overcoating and D-imprinting (+,D). A clear trend of increased selectivity towards the imprinted enantiomer can be seen for both coated and noncoated samples. FIG. 18 shows exemplary normalized enantiomeric concentrations (concentration after 125 hours of reaction time divided by the concentration at reaction start) for a coated BiOCl plate without imprinting (+,−) and for a coated BiOCl plate with L-LeuGly imprinting (+,L). The imprinted plate showed a significant enrichment of the counter enantiomer (D-LeuGly), while the non-imprinted plate shows only slight differences between the two enantiomers.

1. A photocatalytic unit for increasing the relative amount of at least one first stereoisomer of a compound with respect to at least one second stereoisomer of the compound in a mixture comprising said first and second stereoisomers, the unit having
a photocatalytic substrate comprising at least one photocatalyst,
at least one non-photocatalytic coating layer substantially coating said photocatalytic substrate, and
a plurality of spaced-apart open molecular cavities defined at an external surface of the unit, the cavities being sized and shaped to correspond to a size and shape of said second stereoisomer, each of the cavities having at least a base portion thereof constituted by said photocatalytic substrate.

2. The photocatalytic unit of claim 1, wherein each of said cavities has sidewalls, extending from the base portion towards an opening of the cavity, the sidewalls having a bottom portion formed in said photocatalytic substrate and a top portion formed in said non-photocatalytic coating layer.

3. The photocatalytic unit of claim 1, wherein each of said cavities has sidewalls, extending from the base portion towards an opening of the cavity, the sidewalls being substantially defined within said non-photocatalytic coating layer.

4. (canceled)

5. The photocatalytic unit of claim 1, wherein said photocatalytic substrate is in a form selected from the group consisting of a planar form, a particulate form, a porous homogenous solid body, and a non-porous homogenous solid body.

6. (canceled)

7. The photocatalytic unit of claim 1, wherein said photocatalytic substrate comprises a core coated by a layer of said at least one photocatalyst.

8. (canceled)

9. The photocatalytic unit of claim 1, wherein said at least one photocatalyst is selected from the group consisting of oxides containing one element apart from oxygen; oxides having corner-shared octahedral units; binary oxides; oxides having a formula of A₂B₂O₇, where A is a trivalent metal and B is a four valent metal; oxides having the general formula of A₂, B*, B**O₇, where A is a trivalent metal, B* is a trivalent metal and B** is a pentavalent metal; oxides having the general formula of AB**O₄, where A is a trivalent metal, and B** is a pentavalent metal; oxyhalides and mixtures of such oxyhalides; nitrides; oxynitrides; oxysulfates; metal organic frameworks (MIL177); polyoxometalites (POMs); and any mixture or combination thereof.

10. The photocatalytic unit of claim 1, wherein said at least one photocatalyst comprises oxides, sulfates, sulfides, oxyhalides, nitrides, oxynitrides, selenides, carbides, phosphates, polyoxometalites, and/or metalorganic complexes, that comprise at least one of cadmium, cerium, gallium, iron, tungsten, thallium, lanthanum, yttrium, indium, vanadium, silver, molybdenum, tin, silicon, strontium, lead, astatine, chromium, antimony, selenium, or any oxide, carbide, nitride, sulfide, halide thereof, or any mixture or alloy thereof, doped or undoped by at least one dopant.

11. The photocatalytic unit of claim 1, wherein said at least one photocatalysts is selected from TiO₂, Bi₂O₃, WO₃, ZnO, NbO₆, TiO₆, TaO₆, InNbO₄, InTaO₄, BiNbO₄, BiTaO₄, Ga₂BiTaO₇, Bi₂FeNbO₇, Gd₃TaO₇, Bi₂AlNbO₇, Bi₂GaNbO₇, Bi₂InNbO₇, Y₃TaO₇, Yb₃NbO₇, La₃NbO₇, La₃TaO₇, CaTiO₃, SrTiO₃, Sr₃Ti₂O₇, Sr₄Ti₃O₁₀, K₂La₂Ti₃O₁₀, Rb₂La₂Ti₃O₁₀, Cs₂La₂Ti₃O₁₀, CsLa₂Ti₂NbO₁₀, La₂TiO₅, La₂Ti₃O₉, La₂Ti₂O₇, La₂Ti₂O₇:Ba, La₄CaTi₅O₁₇, KTiNbO₅, Na₂Ti₆O₁₃, BaTi₄O₉, Gd₂Ti₂O₇, Y₂Ti₂O₇, α-Fe₂O₃, K₄Nb₆O₁₇, Rb₄Nb₆O₁₇, Ca₂Nb₂O₇, Sr₂Nb₂O₇, Ba₅Nb₄O₁₅, NaCa₂Nb₃O₁₀, ZnNb₂O₆, Cs₂Nb₄O₁₁, La₃NbO₇, Ta₂O₅, K₂PrTaO₁₅, K₃Ta₃Si₂O₁₃, K₃Ta₃B₂O₁₂, LiTaO₃, NaTaO₃, KTaO₃, AgTaO₃, KTaO₃:Zr, NaTaO₃:La, NaTaO₂:Sr, Na₂Ta₂O₆, K₂Ta₂O₆, CaTa₂O₆, SrTa₂O₆, BaTa₂O₆, NiTa₂O₆, Rb₄Ta₆O₁₇, Ca₂Ta₂O₇, Sr₂Ta₂O₇, K₂SrTa₂O₇, RbNdTa₂O₇, H₂La_{2/3}Ta₂O₇, K₂Sr_{1.5}Ta₃O₁₀, LiCa₂Ta₃O₁₀, KNa₂Ta₃O₁₀, Sr₅Ta₄O₁₅, Ba₅Ta₄O₁₅, H_{1.8}Sr_{0.81}Bi_{0.19}Ta₂O₇, Mg—Ta oxide, LaTaO₄, La₃TaO₇, PbWO₄, RbWNbO₆, RbWTaO₆, CeO₂:Sr, BaCeO₃, NaInO₂, CaIn₂O₄, SrIn₂O₄, LaInO₃, YₓIn₂₋ₓO₃ (0<x<2), NaSbO₃, CaSb₂O₆, Ca₂Sb₂O₇, Sr₂Sb₂O₇, Sr₂SnO₄, ZnGa₂O₄, Zn₂GeO₄, LiInGeO₄, Ga₂O₃, Ga₂O₃:Zn, LaTiO₂N, Ca_{0.25}La_{0.75}TiO_{2.25}N_{0.75}, TaON, Ta₃Ns, CaNbO₂N, CaTaO₂N, SrTaO₂N, BaTaO₂N, LaTaO₂N, Y₂Ta₂O₅N₂, Sm₂Ti₂O₅S₂, La—In oxysulfide, La₃NbO₇, Bi₂SbVO₇, BiOCl, BiOI, BiOBr, BiOF, BiOClₓBr₁₋ₓ (0<x<1), graphitic carbon nitride, and any mixture or combination thereof.

12. (canceled)

13. The photocatalytic unit of claim 1, wherein said non-photocatalytic coating layer comprises at least one oxide, at least one hydroxide, or at least one metal salt.

14. (canceled)

15. The photocatalytic unit of claim 1, wherein said non-photocatalytic coating layer comprises at least one non-photocatalytic material selected from Al₂O₃, SiO₂, ZrO₂, HfO₂, La₂O₃, Y₂O₃, CeO₂, SnO₂, SnO, SrS, BaS, and Ce₂(CO₃)₃ and any mixture thereof.

16. The photocatalytic unit of claim 13, wherein said photocatalyst is selected from titanium dioxide, a binary or ternary oxide of bismuth, a binary or ternary oxide of zinc, and graphitic carbon nitride, and mixtures thereof, and said non-photocatalytic coating layer comprises at least one non-photocatalytic material selected from Al₂O₃, SiO₂, ZrO₂, HfO₂, La₂O₃, Y₂O₃, CeO₂, SnO₂, SnO and mixtures thereof.

17. (canceled)

18. The photocatalytic unit of claim 1, wherein at least a portion of a surface of the cavity is associated with one or more binding increasing moieties.

19. A process of preparing a photocatalytic unit for increasing the relative amount of at least one first stereoisomer of a compound with respect to at least one second stereoisomer of the compound in a mixture comprising said first and second stereoisomers, said method comprising:
(a) associating molecules of said second stereoisomer onto a surface of a photocatalytic substrate that comprises at least one photocatalyst;
(b) selectively coating said surface by at least one non-photocatalytic material to obtain a non-photocatalytic coating layer on the photocatalytic substrate without substantially overcoating said second stereoisomer molecules; and
(c) applying conditions onto the coated photocatalytic substrate to degrade said molecules of second stereoisomer, thereby obtaining a photocatalytic unit comprising a photocatalytic substrate that comprises at least one photocatalyst, at least one non-photocatalytic coating layer substantially coating said photocatalytic substrate, with a plurality of spaced-apart open molecular cavities defined at an external surface of the unit, the cavities being sized and shaped to correspond to a size and shape of said second enantiomer, each of the cavities having at least a base portion thereof constituted by said photocatalytic substrate and sidewalls extending from the base portion towards an opening of the cavity, the sidewalls being substantially defined within said non-photocatalytic coating layer.

20. The process of claim 19, wherein step (a) is preceded by a step (a0), step (a0) comprises preparing said photocatalytic substrate.

21. (canceled)

22. The process of claim 19, wherein the second stereoisomer is associated at step (a) with the surface of the photocatalytic substrate by introducing the photocatalytic substrate into a solution that contains the second stereoisomer.

23. The process of claim 19, further comprising a step (d) following step (c), for processing the photocatalytic units into a free-standing film form or a carrier-supported film.

24. A process of preparing a photocatalytic unit for increasing the relative amount of at least one first stereoisomer of a compound with respect to at least one second stereoisomer of the compound in a mixture comprising said first and second stereoisomers, said method comprising:
(a′) preparing a photocatalytic substrate that comprises at least one photocatalyst having molecules of said second stereoisomer at least partially embedded into onto a surface of said substrate;
(b′) selectively coating said surface by at least one non-photocatalytic material to obtain a non-photocatalytic coating layer on the photocatalytic substrate without substantially overcoating said second stereoisomer molecules; and
(c′) applying conditions onto the coated photocatalytic substrate to degrade said molecules of second stereoisomer, thereby obtaining a photocatalytic unit comprising a photocatalytic substrate comprising at least one photocatalyst, at least one non-photocatalytic coating layer substantially coating said photocatalytic substrate and a plurality of spaced-apart open molecular cavities defined at an external surface of the unit, the cavities being sized and shaped to correspond to a size and shape of said second stereoisomer, each of the cavities having at least a base portion thereof constituted by said photocatalytic substrate and sidewalls extending from the base portion towards an opening of the cavity, the sidewalls having a bottom portion formed in said photocatalytic substrate and a top portion formed in said non-photocatalytic coating layer.

25. The process of claim 24, wherein step (a′) comprises mixing said second stereoisomer with a precursor of the photocatalyst.

26. The process of claim 24, wherein step (a′) is carried out in a solution that comprises one or more solvents, molecules of said second stereoisomer and said precursors.

27.-28. (canceled)

29. The process of claim 25, further comprising a step (d′) following step (c′), for processing the photocatalytic units into a free-standing film form or a carrier-supported film.

30.-45. (canceled)
